(19) United States
(12) Patent Application Publication
(10) Pub. No.: US 2026/0172195 A1
(43) Pub. Date: Jun. 18, 2026

(54) CONFIGURING CONTROL RESOURCE SETS FOR PORTIONS OF BANDWIDTH PARTS

(71) Applicant: QUALCOMM Incorporated, San Diego, CA (US)

(72) Inventors: Diana MAAMARI, San Diego, CA (US); Gabi SARKIS, San Diego, CA (US); Muhammad Sayed Khairy ABDELGHAFFAR, San Jose, CA (US); Mostafa KHOSHNEVISAN, San Diego, CA (US)

(21) Appl. No.: 18/986,490

(22) Filed: Dec. 18, 2024

(51) Int. Cl. H04L 5/00; H04L 1/1607

(52) U.S. Cl. CPC H04L 5/0053; H04L 1/1614

(57) ABSTRACT

Methods, systems, and devices for wireless communications are described. The described techniques may enable a user equipment (UE) to adapt a configured control resource set (CORESET) based on whether the UE is communicating via one or more overlapping portions of a bandwidth. For example, the UE may be configured with a set of physical downlink control channel (PDCCH) candidates for a first portion of the bandwidth, and may exclude or redistribute one or more candidates that fall outside of a second portion of the bandwidth (e.g., a portion that falls within the first portion) when the UE communicates via the second portion. Additionally, or alternatively, the UE may be configured with a superset of PDCCH candidates, and may select which of the configured candidates to use based on whether the UE communicates via the first portion or the second portion.

### FIELD OF TECHNOLOGY

The following relates to wireless communications, including configuring control resource sets for portions of bandwidth parts.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving first signaling indicating a configuration for a set of multiple portions of a bandwidth, the set of multiple portions of the bandwidth including a first portion of the bandwidth and a second portion of the bandwidth that at least partially overlaps with the first portion of the bandwidth, receiving second signaling indicating configuration information associated with monitoring the first portion of the bandwidth and monitoring the second portion of the bandwidth, monitoring for one or more first transmissions via the first portion of the bandwidth in a first valid set of monitoring occasions according to the configuration for the set of multiple portions of the bandwidth and according to the configuration information associated with monitoring the first portion of the bandwidth, receiving third signaling indicating for the UE to operate in the second portion of the bandwidth, and monitoring for one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

A UE for wireless communication is described. The UE may include one or more memories storing processor executable code, and one or more processors coupled with the one or more memories. The one or more processors may individually or collectively be operable to execute the code to cause the UE to receive first signaling indicating a configuration for a set of multiple portions of a bandwidth, the set of multiple portions of the bandwidth including a first portion of the bandwidth and a second portion of the bandwidth that at least partially overlaps with the first portion of the bandwidth, receive second signaling indicating configuration information associated with monitoring the first portion of the bandwidth and monitoring the second portion of the bandwidth, monitor for one or more first transmissions via the first portion of the bandwidth in a first valid set of monitoring occasions according to the configuration for the set of multiple portions of the bandwidth and according to the configuration information associated with monitoring the first portion of the bandwidth, receive third signaling indicating for the UE to operate in the second portion of the bandwidth, and monitor for one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

Another UE for wireless communication is described. The UE may include means for receiving first signaling indicating a configuration for a set of multiple portions of a bandwidth, the set of multiple portions of the bandwidth including a first portion of the bandwidth and a second portion of the bandwidth that at least partially overlaps with the first portion of the bandwidth, means for receiving second signaling indicating configuration information associated with monitoring the first portion of the bandwidth and monitoring the second portion of the bandwidth, means for monitoring for one or more first transmissions via the first portion of the bandwidth in a first valid set of monitoring occasions according to the configuration for the set of multiple portions of the bandwidth and according to the configuration information associated with monitoring the first portion of the bandwidth, means for receiving third signaling indicating for the UE to operate in the second portion of the bandwidth, and means for monitoring for one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

A non-transitory computer-readable medium storing code for wireless communication is described. The code may include instructions executable by one or more processors to receive first signaling indicating a configuration for a set of multiple portions of a bandwidth, the set of multiple portions of the bandwidth including a first portion of the bandwidth and a second portion of the bandwidth that at least partially overlaps with the first portion of the bandwidth, receive second signaling indicating configuration information associated with monitoring the first portion of the bandwidth and monitoring the second portion of the bandwidth, monitor for one or more first transmissions via the first portion of the bandwidth in a first valid set of monitoring occasions according to the configuration for the set of multiple portions of the bandwidth and according to the configuration information associated with monitoring the first portion of the bandwidth, receive third signaling indicating for the UE to operate in the second portion of the bandwidth, and monitor for one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

In some examples of the method, UEs, and non-transitory computer-readable medium described herein, the configuration information associated with monitoring indicates a set of monitoring occasions including the first valid set of monitoring occasions and the second valid set of monitoring occasions.

Some examples of the method, UEs, and non-transitory computer-readable medium described herein may further include operations, features, means, or instructions for selecting, in response to the first signaling, the first valid set of monitoring occasions and selecting, in response to the second signaling, the second valid set of monitoring occasions.

Some examples of the method, UEs, and non-transitory computer-readable medium described herein may further include operations, features, means, or instructions for receiving, via the first signaling, a first monitoring occasion mask associated with the first portion of the bandwidth and a second monitoring occasion mask associated with the second portion of the bandwidth.

In some examples of the method, UEs, and non-transitory computer-readable medium described herein, the first monitoring occasion mask and the second monitoring occasion mask include bitmaps indicating whether one or more monitoring occasions of the set of monitoring occasions may be valid.

In some examples of the method, UEs, and non-transitory computer-readable medium described herein, the configuration information associated with monitoring indicates the first valid set of monitoring occasions.

In some examples of the method, UEs, and non-transitory computer-readable medium described herein, the configuration information associated with monitoring indicates the second valid set of monitoring occasions.

In some examples of the method, UEs, and non-transitory computer-readable medium described herein, the second valid set of monitoring occasions excludes one or more valid monitoring occasions of the first valid set of monitoring occasions based on the one or more valid monitoring occasions of the first valid set of monitoring occasions being located outside of the second portion of the bandwidth.

Some examples of the method, UEs, and non-transitory computer-readable medium described herein may further include operations, features, means, or instructions for redistributing one or more valid monitoring occasions of the first valid set of monitoring occasions to be within the second portion of the bandwidth based on the one or more valid monitoring occasions of the first valid set of monitoring occasions being located outside of the second portion of the bandwidth.

Some examples of the method, UEs, and non-transitory computer-readable medium described herein may further include operations, features, means, or instructions for computing one or more indices associated with a set of monitoring occasions, the set of monitoring occasions including the first valid set of monitoring occasions and the second valid set of monitoring occasions, selecting, in response to the first signaling, the first valid set of monitoring occasions, and selecting, in response to the second signaling, the second valid set of monitoring occasions.

In some examples of the method, UEs, and non-transitory computer-readable medium described herein, the first valid set of monitoring occasions includes at least one monitoring occasion of the second valid set of monitoring occasions.

In some examples of the method, UEs, and non-transitory computer-readable medium described herein, the first valid set of monitoring occasions excludes one or more monitoring occasions of the second valid set of monitoring occasions.

Some examples of the method, UEs, and non-transitory computer-readable medium described herein may further include operations, features, means, or instructions for monitoring the first valid set of monitoring occasions via a first search space set associated with a first periodicity and monitoring the second valid set of monitoring occasions via a second search space set associated with a second periodicity.

Some examples of the method, UEs, and non-transitory computer-readable medium described herein may further include operations, features, means, or instructions for transmitting a feedback message in response to the second signaling, the feedback message including an indication of the second portion of the bandwidth.

A method for wireless communication by a network entity is described. The method may include outputting first signaling indicating a configuration for a set of multiple portions of a bandwidth, the set of multiple portions of the bandwidth including a first portion of the bandwidth and a second portion of the bandwidth that at least partially overlaps with the first portion of the bandwidth, outputting second signaling indicating configuration information associated with monitoring the first portion of the bandwidth and monitoring the second portion of the bandwidth, outputting, to a UE, one or more first transmissions via the first portion of the bandwidth in a first valid set of monitoring occasions according to the configuration for the set of multiple portions of the bandwidth and according to the configuration information associated with monitoring the first portion of the bandwidth, outputting third signaling indicating for the UE to operate in the second portion of the bandwidth, and outputting one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

A network entity for wireless communication is described. The network entity may include one or more memories storing processor executable code, and one or more processors coupled with the one or more memories. The one or more processors may individually or collectively be operable to execute the code to cause the network entity to output first signaling indicating a configuration for a set of multiple portions of a bandwidth, the set of multiple portions of the bandwidth including a first portion of the bandwidth and a second portion of the bandwidth that at least partially overlaps with the first portion of the bandwidth, output second signaling indicating configuration information associated with monitoring the first portion of the bandwidth and monitoring the second portion of the bandwidth, output, to a UE, one or more first transmissions via the first portion of the bandwidth in a first valid set of monitoring occasions according to the configuration for the set of multiple portions of the bandwidth and according to the configuration information associated with monitoring the first portion of the bandwidth, output third signaling indicating for the UE to operate in the second portion of the bandwidth, and output one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

Another network entity for wireless communication is described. The network entity may include means for outputting first signaling indicating a configuration for a set of multiple portions of a bandwidth, the set of multiple portions of the bandwidth including a first portion of the bandwidth and a second portion of the bandwidth that at least partially overlaps with the first portion of the bandwidth, means for outputting second signaling indicating configuration information associated with monitoring the first portion of the bandwidth and monitoring the second portion of the bandwidth, means for outputting, to a UE, one or more first transmissions via the first portion of the bandwidth in a first valid set of monitoring occasions according to the configuration for the set of multiple portions of the bandwidth and according to the configuration information associated with monitoring the first portion of the bandwidth, means for outputting third signaling indicating for the UE to operate in the second portion of the bandwidth, and means for outputting one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

A non-transitory computer-readable medium storing code for wireless communication is described. The code may include instructions executable by one or more processors to output first signaling indicating a configuration for a set of multiple portions of a bandwidth, the set of multiple portions of the bandwidth including a first portion of the bandwidth and a second portion of the bandwidth that at least partially overlaps with the first portion of the bandwidth, output second signaling indicating configuration information associated with monitoring the first portion of the bandwidth and monitoring the second portion of the bandwidth, output, to a UE, one or more first transmissions via the first portion of the bandwidth in a first valid set of monitoring occasions according to the configuration for the set of multiple portions of the bandwidth and according to the configuration information associated with monitoring the first portion of the bandwidth, output third signaling indicating for the UE to operate in the second portion of the bandwidth, and output one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

In some examples of the method, network entities, and non-transitory computer-readable medium described herein, the configuration information associated with monitoring indicates a set of monitoring occasions including the first valid set of monitoring occasions and the second valid set of monitoring occasions.

Some examples of the method, network entities, and non-transitory computer-readable medium described herein may further include operations, features, means, or instructions for selecting, in response to the first signaling, the first valid set of monitoring occasions and selecting, in response to the second signaling, the second valid set of monitoring occasions.

Some examples of the method, network entities, and non-transitory computer-readable medium described herein may further include operations, features, means, or instructions for outputting, via the first signaling, a first monitoring occasion mask associated with the first portion of the bandwidth and a second monitoring occasion mask associated with the second portion of the bandwidth.

In some examples of the method, network entities, and non-transitory computer-readable medium described herein, the first monitoring occasion mask and the second monitoring occasion mask include bitmaps indicating whether one or more monitoring occasions of the set of monitoring occasions may be valid.

In some examples of the method, network entities, and non-transitory computer-readable medium described herein, the configuration information associated with monitoring indicates the first valid set of monitoring occasions.

In some examples of the method, network entities, and non-transitory computer-readable medium described herein, the configuration information associated with monitoring indicates the second valid set of monitoring occasions.

In some examples of the method, network entities, and non-transitory computer-readable medium described herein, the second valid set of monitoring occasions excludes one or more valid monitoring occasions of the first valid set of monitoring occasions based on the one or more valid monitoring occasions of the first valid set of monitoring occasions being located outside of the second portion of the bandwidth.

Some examples of the method, network entities, and non-transitory computer-readable medium described herein may further include operations, features, means, or instructions for redistributing one or more valid monitoring occasions of the first valid set of monitoring occasions to be within the second portion of the bandwidth based on the one or more valid monitoring occasions of the first valid set of monitoring occasions being located outside of the second portion of the bandwidth.

Some examples of the method, network entities, and non-transitory computer-readable medium described herein may further include operations, features, means, or instructions for computing one or more indices associated with a set of monitoring occasions, the set of monitoring occasions including the first valid set of monitoring occasions and the second valid set of monitoring occasions, selecting, in response to the first signaling, the first valid set of monitoring occasions, and selecting, in response to the second signaling, the second valid set of monitoring occasions.

In some examples of the method, network entities, and non-transitory computer-readable medium described herein, the first valid set of monitoring occasions includes at least one monitoring occasion of the second valid set of monitoring occasions.

In some examples of the method, network entities, and non-transitory computer-readable medium described herein, the first valid set of monitoring occasions excludes one or more monitoring occasions of the second valid set of monitoring occasions.

Some examples of the method, network entities, and non-transitory computer-readable medium described herein may further include operations, features, means, or instructions for outputting the one or more first transmissions via a first search space set associated with a first periodicity and outputting the one or more second transmissions via a second search space set associated with a second periodicity.

Some examples of the method, network entities, and non-transitory computer-readable medium described herein may further include operations, features, means, or instructions for receiving a feedback message in response to the second signaling, the feedback message including an indication of the second portion of the bandwidth, where outputting the one or more second transmissions via the second valid set of monitoring occasions may be based on receiving the feedback message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports configuring control resource sets for portions of bandwidth parts in accordance with one or more aspects of the present disclosure.

FIG. 2 shows an example of a wireless communications system that supports configuring control resource sets for portions of bandwidth parts in accordance with one or more aspects of the present disclosure.

FIGS. 3A and 3B show examples of resource diagrams that support configuring control resource sets for portions of bandwidth parts in accordance with one or more aspects of the present disclosure.

FIG. 4 shows an example of a resource diagram that supports configuring control resource sets for portions of bandwidth parts in accordance with one or more aspects of the present disclosure.

FIG. 5 shows an example of a process flow that supports configuring control resource sets for portions of bandwidth parts in accordance with one or more aspects of the present disclosure.

FIGS. 6 and 7 show block diagrams of devices that support configuring control resource sets for portions of bandwidth parts in accordance with one or more aspects of the present disclosure.

FIG. 8 shows a block diagram of a communications manager that supports configuring control resource sets for portions of bandwidth parts in accordance with one or more aspects of the present disclosure.

FIG. 9 shows a diagram of a system including a device that supports configuring control resource sets for portions of bandwidth parts in accordance with one or more aspects of the present disclosure.

FIGS. 10 and 11 show block diagrams of devices that support configuring control resource sets for portions of bandwidth parts in accordance with one or more aspects of the present disclosure.

FIG. 12 shows a block diagram of a communications manager that supports configuring control resource sets for portions of bandwidth parts in accordance with one or more aspects of the present disclosure.

FIG. 13 shows a diagram of a system including a device that supports configuring control resource sets for portions of bandwidth parts in accordance with one or more aspects of the present disclosure.

FIGS. 14 through 15 show flowcharts illustrating methods that support configuring control resource sets for portions of bandwidth parts in accordance with one or more aspects of the present disclosure.

### DETAILED DESCRIPTION

In some wireless communications systems, a user equipment (UE) may communicate with a network entity via a portion of a bandwidth (e.g., a bandwidth part (BWP), a portion of a BWP, a frequency subband allocation, a resource block (RB), an RB group (RBG), another part of a frequency bandwidth). The network entity may configure the UE with a control resource set (CORESET) of candidate resources (e.g., physical downlink control channel (PDCCH) resources) via which the UE may monitor for messages from the network entity. In some examples, the UE may communicate with the network entity via one or more portions of the bandwidth. For example, the UE may operate in a first mode in which the UE may receive messages via a full BWP, and a second mode in which the UE may receive messages via a subset of the BWP. In such examples, the UE may not use a same CORESET for the full BWP as for the subset of the BWP.

Accordingly, techniques described herein may enable the UE to adapt a configured CORESET based on whether the UE is communicating via one or more overlapping portions of a bandwidth (e.g., via a full BWP or via one or more portions of the BWP). For example, the UE may be configured with a set of PDCCH candidates for a first portion of the bandwidth, and may exclude one or more candidates that fall outside of a second portion of the bandwidth (e.g., a second portion that falls within the first portion) when the UE communicates via the second portion. Additionally, or alternatively, the UE may be configured with the set of PDCCH candidates for the first portion, and may redistribute the PDCCH candidates when the UE communicates via the second portion. Additionally, or alternatively, the UE may be configured with a superset of PDCCH candidates including candidates for the first portion and candidates for the second portion, and may select which of the configured candidates to used based on whether the UE communicates via the first portion or the second portion.

Aspects of the disclosure are initially described in the context of wireless communications systems. Aspects of the disclosure are further illustrated by and described with reference to resource diagrams, process flows, apparatus diagrams, system diagrams, and flowcharts that relate to configuring control resource sets for portions of bandwidth parts.

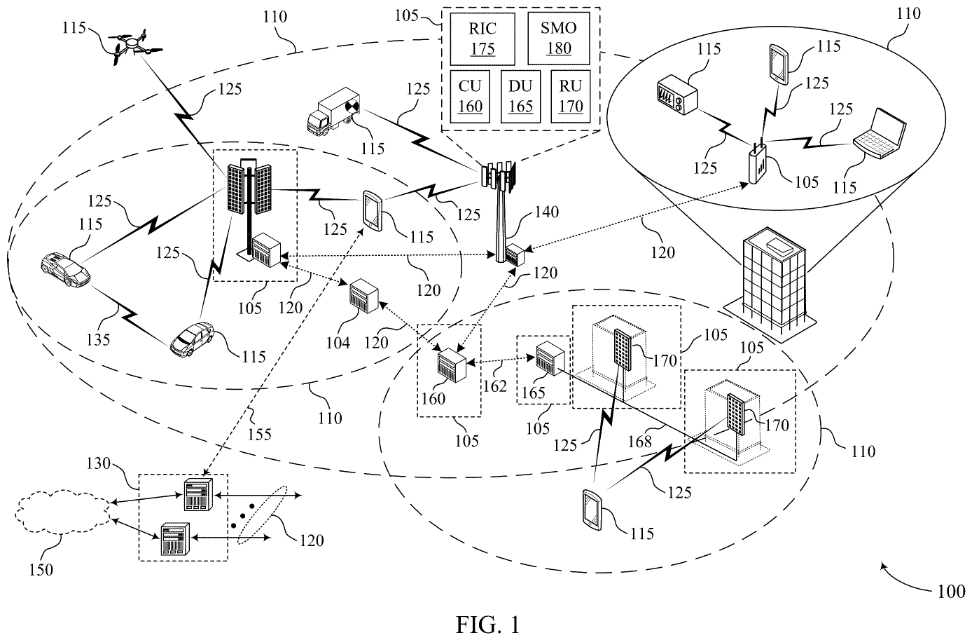

FIG. 1 shows an example of a wireless communications system 100 that supports configuring control resource sets for portions of bandwidth parts in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support configuring control resource sets for portions of bandwidth parts as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023). Each frame may include multiple consecutively-numbered subframes or

slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications or using light adaptation with scheduling restrictions as described herein), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, a UE 115 may adapt a configured CORESET based on whether the UE is communicating via one or more overlapping portions of a bandwidth (e.g., via a full BWP or via one or more portions of the BWP). For example, a network entity 105 may configure the UE 115 with a set of PDCCH candidates for a first portion of the bandwidth, and may exclude one or more candidates that fall outside of a second portion of the bandwidth (e.g., a second portion that falls within the first portion) when the UE 115 communicates via the second portion. Additionally, or alternatively, the UE 115 may be configured with the set of PDCCH candidates for the first portion, and may redistribute the PDCCH candidates when the UE 115 communicates via the second portion. Additionally, or alternatively, the UE 115 may be configured with a superset of PDCCH candidates including candidates for the first portion and candidates for the second portion, and may select which of the configured candidates to used based on whether the UE 115 communicates via the first portion or the second portion.

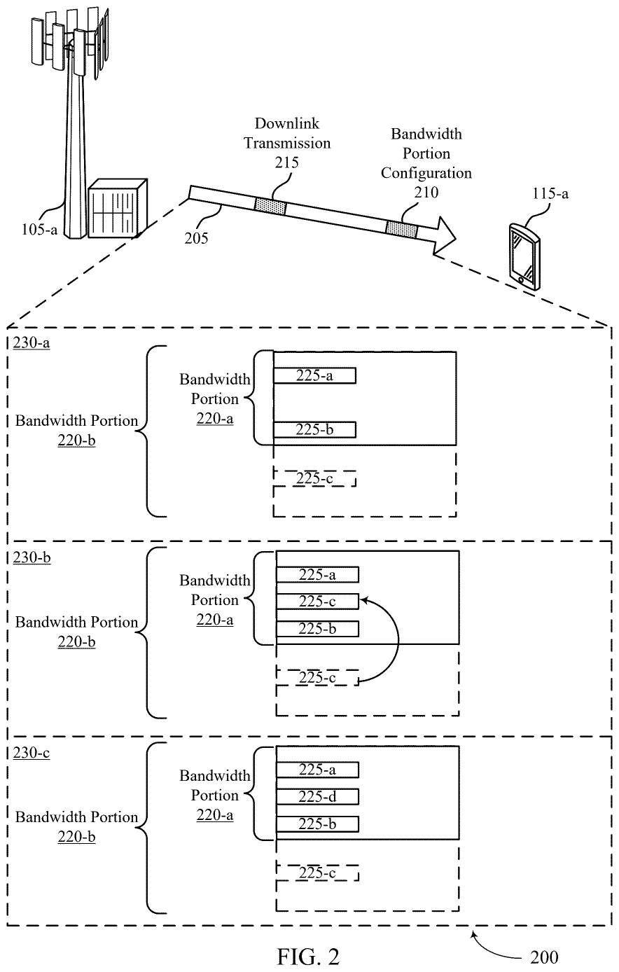

FIG. 2 shows an example of a wireless communications system 200 that supports configuring control resource sets for portions of bandwidth parts in accordance with one or more aspects of the present disclosure. The wireless communications system 200 may implement or may be implemented by aspects of the wireless communications system 100. For example, the wireless communications system 200 may be implemented by a UE 115 (e.g., a UE 115-a) or a network entity 105 (e.g., a network entity 105-a), which may be examples of the corresponding devices as described with reference to FIG. 1.

In some examples of the wireless communications system 200, a UE 115-a may communicate with a network entity 105-a via one or more channels. For example, the UE 115-a may receive messages (e.g., downlink transmission 215) from the network entity 105-a via a downlink channel 205. The downlink transmissions 215 may be, for example, physical downlink control channel (PDCCH) messages, such as downlink control information (DCI) messages. The downlink transmissions 215 may, additionally, or alternatively, be physical downlink shared channel (PDSCH) messages, MAC control element (MAC-CE) messages, RRC messages, and the like.

In some examples, the UE 115-b may receive the downlink transmissions 215 via one or more portions of a bandwidth. For example, the UE 115-b may receive the downlink transmissions 215 via a BWP, which may enable relatively faster communications with relatively low signaling overhead related to adaptation of radio parameters. For example, the network entity 105-a may configure the UE 115-a with a set of RRC parameters for each BWP of a bandwidth (e.g., profiles organized in a BWP container). The network entity 105-a may indicate for the UE 115-a to switch from a first BWP to a second BWP (e.g., via RRC, MAC-CE, or DCI signaling). Additionally, or alternatively, the UE 115-a may switch from the first BWP to the second BWP in response to expiration of a BWP inactivity timer (IAT). Such techniques may enable the UE 115-a to switch parameters to reduce power consumption of the UE 115-a, such as communicating via a relatively smaller bandwidth (e.g., 100 MHz as compared to 200 MHz).

In some examples, however, each configuration may be BWP-dependent. That is, to enable BWP switching, the UE 115-a may increase an area cost associated with storing a respective BWP configuration for each BWP, or may increase a latency (e.g., timeline cost) associated with reprogramming configurations for each BWP. Such reprogramming may result in a relatively longer duration associated with switching BWPs (e.g., as a result of time associated with performing hardware and software reconfigurations at the UE 115-a).

In some examples, the UE 115-a may reduce energy consumption by adaptively switching time, frequency, and antenna configurations. The UE 115-a may adaptively switch configurations via one or more methods. For example, the UE 115-a may receive a full RRC reconfiguration message from the network entity 105-a, which may be associated with relatively large overhead and reconfiguration durations. Additionally, or alternatively, the UE 115-a may perform BWP switching (e.g., DCI-based full BWP switching), which may result in a relatively long switching time (e.g., a duration for switching between BWPs, which may include RF retuning, baseband clock set retuning, and reprogramming one or more registers) and may reduce a quality of communications in the wireless communication system 200 as a result of BWP misalignment between the UE 115-a and the network entity 105-a.

Additionally, or alternatively, the UE 115-a may use DCI-based adaptation or light adaptation (e.g., a light or more limited adaptation of BWP switching, which may be a scheduling restriction-based DCI adaptation) of parameters, which may enable relatively more frequency adaptation in deployments of different time, frequency, and antenna configurations. For example, such DCI-based adaptation may reduce an amount of down time for the UE 115-a by decreasing a switching duration and may mitigate the reduction of quality resulting from BWP misalignment. Such a framework may support some dynamic time, frequency, and antenna adaptation (e.g., relatively less adaptation than BWP switching).

In some examples, the light adaptation of parameters may be associated with a relatively smaller application time than other BWP switching techniques (e.g., by reducing a quantity of registers to be reconfigured at the UE 115-a). Light adaptation of parameters may additionally mitigate the reduction of quality resulting from BWP misalignment by enabling the UE 115-a to decode control messages (e.g., DCI messages) from the network entity 105-a in examples in which a switching indication is missed or falsely detected. That is, the UE 115-a and the network entity 105-a may communicate control messages if the UE 115-a and the network entity 105-a operate on different bandwidth portions 220. For example, a DCI format and field size may not change as a result of light adaptation, and a DCI message may accordingly be decodable by the UE 115-a.

Accordingly, in examples in which the UE 115-a uses light adaptation of parameters, signaling between the UE 115-a and the network entity 105-a may remain the same between adaptations, and a scheduling restriction may be applied to adapt the parameters. The UE 115-a may not be reconfigured or reprogrammed (e.g., may not receive an RRC reconfiguration) to support light adaptation, which may reduce a duration for switching between portions of a bandwidth. The switching duration may therefore depend on RF retuning, baseband retuning, and the like rather than register programming.

The scheduling restriction may include a light BWP, where configurations may not change when an RF bandwidth changes such that BWP switching may be triggered relatively more dynamically than some other BWP switching techniques (e.g., light-weight or fast switching based on traffic demand). The scheduling restriction may additionally, or alternatively, include one or more layers, antennas, or modulation and coding schemes (MCSs). For example, rather than BWP switching to enable relatively higher-order MCSs (e.g., larger quadrature amplitude modulation (QAM) MCSs, such as 1K QAM), the scheduling restriction may cause the UE 115-a to use a same MCS table that may not enable scheduling of higher-order MCSs. Additionally, rather than BWP switching to enable a relatively larger quantity of layers, the scheduling restriction may cause the UE 115-a to use a subset of layers (e.g., a restricted quantity of layers).

As an illustrative example, the network entity 105-a may configure the UE 115-a with a rank (e.g., a maximum rank) of 4, but may indicate that the UE 115-a may not be scheduled with rank 4 for a duration. The UE 115-a may accordingly refrain from using rank 4 for the duration, which may decrease power consumption by the UE 115-a. Additionally, or alternatively, the network entity 105-a may configure the UE 115-a with an active BWP of 100 MHz, but may indicate that the UE 115-a may not be scheduled beyond 20 MHz for a duration. The UE 115-a may accordingly refrain from monitoring outside of the 20 MHz for the duration, which may decrease power consumption by the UE 115-a.

In examples in which the network entity 105-a applies a scheduling restriction for the UE 115-a to communicate via one or more bandwidth portions 220, the UE 115-a may expect to receive downlink transmissions 215 via sub-BWPs (e.g., subsets of BWPs, which may include a bandwidth portion 220-b that includes the full BWP, such as 100 MHz and a bandwidth portion 220-a that includes a subset of the BWP, such as 20 MHz). In some examples, the bandwidth portion 220 a and the bandwidth portion 220-b may share one or more baseband configurations. Accordingly, the switching duration may be based on the RF retuning duration. As described herein, the bandwidth portion 220-b may be referred to as an “active BWP” or “carrier bandwidth,” and the bandwidth portion 220-a may be referred to as a “limited bandwidth” or a “subBWP.”

In some examples, a downlink transmission 215 (e.g., a DCI) may not be adapted for the bandwidth portion 220-a. That is, the DCI may be based on a size and configuration of the bandwidth portion 220-b. The network entity 105-a may adapt the operation (e.g., a bandwidth portion 220 monitored by the UE 115-a) via a scheduling restriction. For example, the network entity 105-a may schedule a first slot with the bandwidth portion 220-a and a second slot with the bandwidth portion 220-b. The UE 115-a may determine that a scheduled PDSCH or physical uplink control channel (PUSCH) that exceeds the bandwidth portion 220-a in the first slot is an invalid grant. The UE 115-a may accordingly receive a PDSCH in the first slot via the bandwidth portion 220-a, and may receive a PDSCH in the second slot via the bandwidth portion 220-b (e.g., the slot in which the scheduling limitation may not apply). The network entity 105-a may adapt the scheduling restriction via a DCI message. In some examples, the scheduling restriction techniques described herein may apply to a quantity of layers. That is, the UE 115-a may be configured with a first quantity of layers for a first slot and a second quantity of layers for a second slot (e.g., rather than reconfiguring or switching maximum-rank parameters to adjust the quantity of layers).

In some examples, the network entity 105-a may transmit a bandwidth portion configuration 210 to the UE 115-a that indicates for the UE 115-a to monitor a subset of RBs (e.g., RBs within the bandwidth portion 220-a) for PDSCH messages for one or more first slots (e.g., in accordance with a scheduling restrictions). The bandwidth portion configuration 210 may indicate for the UE 115-a to monitor the full bandwidth portion 220-b for PDSCH messages for one or more second slots. In some examples, however, the UE 115-a may be configured with a quantity of monitoring occasions 225 (e.g., PDCCH candidates, blind decoding occasions) in a CORESET bandwidth and search space set (SSS) for the bandwidth portion 220-b. The UE 115-a may accordingly adapt the monitoring occasions 225 and the SSS during the slots in which the UE 115-a monitors the bandwidth portion 220-a (e.g., without reprogramming or reconfiguring the CORESET and the SSS per bandwidth portion 220).

In some aspects, as illustrated with reference to a resource diagram 230-a, the UE 115-a may exclude one or more monitoring occasions 225 of the bandwidth portion 220-b that fall outside of the bandwidth portion 220-a while the UE 115-a is configured to monitor via the bandwidth portion 220-a. For example, while the UE 115-a is configured to monitor via the bandwidth portion 220-b, the UE 115-a may monitor for PDCCH messages via a monitoring occasion 225-a, a monitoring occasion 225-b, and a monitoring occasion 225-c. While the UE 115-a is configured to monitor via the bandwidth portion 220-b, the UE 115-a may monitor for PDCCH messages via the monitoring occasion 225-a and the monitoring occasion 225-b (e.g., and not the monitoring occasion 225-c). Such techniques may reduce a quantity of monitoring occasions 225 monitored for the UE 115-a, which may reduce a scheduling flexibility of the UE 115-a.

In some examples, the monitoring occasions 225 may be distributed based on the bandwidth portion 220-a (e.g., the relatively more narrow bandwidth portion) or based on the bandwidth portion 220-b (e.g., the relatively more wide bandwidth portion). For example, in examples in which the monitoring occasions 225 are allocated based on the bandwidth portion 220-a, relatively more monitoring occasions 225 may be allocated to the bandwidth portion 220-a, and the UE 115-a may therefore exclude relatively fewer monitoring occasions 225 when the UE 115-a monitors via the bandwidth portion 220-a. In such examples, a blocking probably may be increased and a flexibility and PDCCH capacity may be decreased (e.g., due to the monitoring occasions 225 being relatively closer together).

In examples in which the monitoring occasions 225 are allocated based on the bandwidth portion 220-b, the bandwidth portion 220-a may have a relatively reduced capacity (e.g., due to relatively fewer monitoring occasions 225 being allocated to the bandwidth portion 220-a). That is, the UE 115-a may exclude relatively more monitoring occasions 225 when the UE 115-a monitors via the bandwidth portion 220-a (e.g., when the UE 115-a operates in a low power state). In some examples, the UE 115-a may use a different design (e.g., a different allocation for monitoring occasions) depending on an interleaved CCE to REG mapping.

Additionally, or alternatively, as illustrated with reference to a resource diagram 230-b, the UE 115-a may redistribute one or more monitoring occasions 225 of the bandwidth portion 220-b that fall outside of the bandwidth portion 220-a while the UE 115-a is configured to monitor via the bandwidth portion 220-a. For example, while the UE 115-a is configured to monitor via the bandwidth portion 220-b, the UE 115-a may monitor for PDCCH messages via a monitoring occasion 225-a, a monitoring occasion 225-b, and a monitoring occasion 225-c. While the UE 115-a is configured to monitor via the bandwidth portion 220-b, the UE 115-a may monitor for PDCCH messages via the monitoring occasion 225-a, the monitoring occasion 225-b, and the monitoring occasion 225-c, and may move the monitoring occasion 225-c to be within the bandwidth portion 220-a. Such techniques may not reduce a quantity of monitoring occasions 225 monitored for the UE 115-a, but may result in relatively more latency due to reconfiguration and reprogramming at the UE 115-a.

In such examples, a hashing used to distribute the monitoring occasions 225 may be based on the bandwidth portion 220-b. For example, the monitoring occasion 225-a, the monitoring occasion 225-b, and the monitoring occasion 225-c may be evenly distributed though the bandwidth portion 220-b. In examples in which the UE 115-a monitors via the bandwidth portion 220-a, the UE 115-a may move (e.g., wrap) the monitoring occasion 225-c to be located within the bandwidth portion 220-a. The monitoring occasion 225-a, the monitoring occasion 225-b, and the monitoring occasion 225-c may therefore be evenly distributed though the bandwidth portion 220-a. In some examples, the UE 115-a may identify an index associated with the monitoring occasions 225 (e.g., including the monitoring occasion 225-d) based on a formula (e.g., a formula defined according to a technical specification) indicating one or more CCE indexes for an aggregation level. In some examples, the formula may include a modulo operation (e.g., with respect to a quantity of CCEs N_{CCE} in the bandwidth portion 220-a and a CCE aggregation level L, such as mod(└NCCE┘/L), or with respect to a starting index of the monitoring occasion 225-c and a size of the bandwidth portion 220-a).

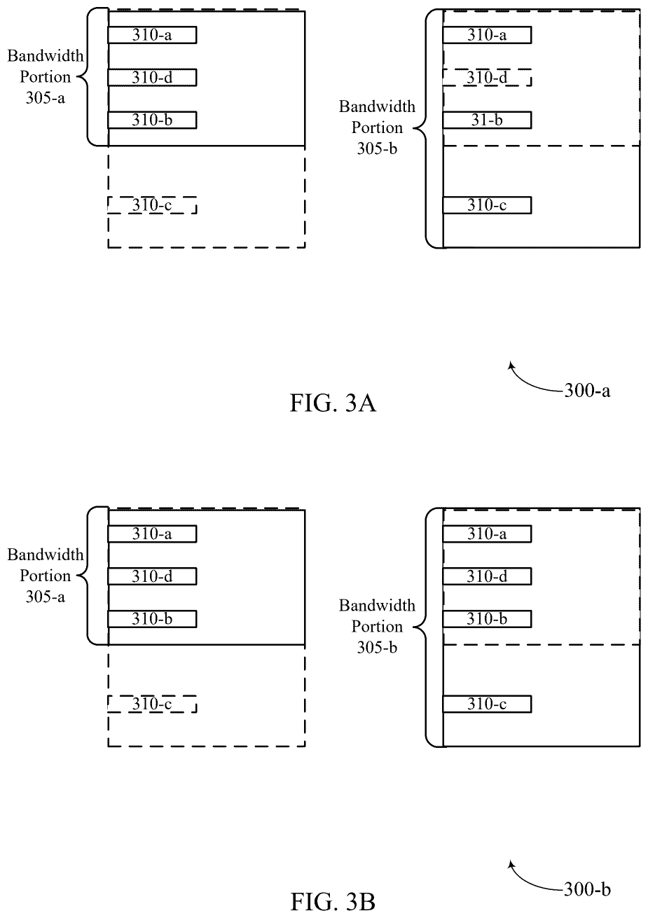

Additionally, or alternatively, as illustrated with reference to a resource diagram 230-c, the network entity 105-a may configure the UE 115-a with a superset of monitoring occasions 225. The UE 115-a may select monitoring occasions 225 of the superset based on whether the UE 115-a is configured to monitor via the bandwidth portion 220-a or the bandwidth portion 220-b. For example, while the UE 115-a is configured to monitor via the bandwidth portion 220-b, the UE 115-a may monitor for PDCCH messages via a monitoring occasion 225-a, a monitoring occasion 225-b, and a monitoring occasion 225-c, and may not monitor via the monitoring occasion 225-d. While the UE 115-a is configured to monitor via the bandwidth portion 220-b, the UE 115-a may monitor for PDCCH messages via the monitoring occasion 225-a, the monitoring occasion 225-b, and the monitoring occasion 225-d, and may not monitor via the monitoring occasion 225-c. Such techniques are described in further detail with reference to FIGS. 3A and 3B. In some examples, the UE 115-a may monitor for PDCCH messages via a same quantity of CCEs and blind decodes via the bandwidth portion 220-a and via the bandwidth portion 220-b.

In some examples, if one or more monitoring occasions 225 for symbols configured for the bandwidth portion 220-a are different (e.g., separate) from one or more monitoring occasions 225 for symbols configured for the bandwidth portion 220-b, the network entity 105-a may use a subset of the monitoring occasions 225 during a duration between a time at which the network entity 105-a indicates for the UE 115-a to switch from the bandwidth portion 220-a to the bandwidth portion 220-b (e.g., or vice-versa).

For example, the network entity 105-a may transmit a control message indicating for the UE 115-a to switch from the bandwidth portion 220-a to the bandwidth portion 220-b. The network entity 105-a may transmit downlink transmissions 215 via one or more monitoring occasions 225 that are common between the monitoring occasions 225 configured for the bandwidth portion 220-a and monitoring occasions 225 configured for the bandwidth portion 220-b (e.g., overlapping PDCCH candidates, such as the monitoring occasion 225-a and the monitoring occasion 225-b). The UE 115-a may transmit a feedback message (e.g., a HARQ-ACK message) to the network entity 105-a acknowledging receipt of the control message and/or indicating that the UE 115-a will switch from the bandwidth portion 220-a to the bandwidth portion 220-b as indicated. The network entity 105-a may, in response to receiving the feedback message, transmit downlink transmissions 215 via any of the monitoring occasions 225-a configured for the bandwidth portion 220-b (e.g., including monitoring occasions 225 that may not overlap with monitoring occasions 225 configured for the bandwidth portion 220-a).

In some aspects, the network entity 105-a may configure the UE 115-a with a same quantity of monitoring occasions 225 for each configured bandwidth portion 220. That is, the UE 115-a may monitor via a first quantity of monitoring occasions 225 in symbols in which the UE 115-a is configured to monitor via the bandwidth portion 220-a, and may monitor via the first quantity of monitoring occasions 225 in symbols in which the UE 115-a is configured to monitor via the bandwidth portion 220-b. Additionally, or alternatively, (e.g., if the UE 115-a is a relatively higher capability UE 115), the network entity 105-a may configure the UE 115-a with a larger quantity of monitoring occasions 225 for a wider bandwidth portion 220 as compared to a more narrow bandwidth portion 220. For example, the UE 115-a may monitor via a first quantity of monitoring occasions 225 in symbols in which the UE 115-a is configured to monitor via the bandwidth portion 220-a, and may monitor via a second quantity of monitoring occasions 225 in symbols in which the UE 115-a is configured to monitor via the bandwidth portion 220-b, where the second quantity is greater than the first quantity.

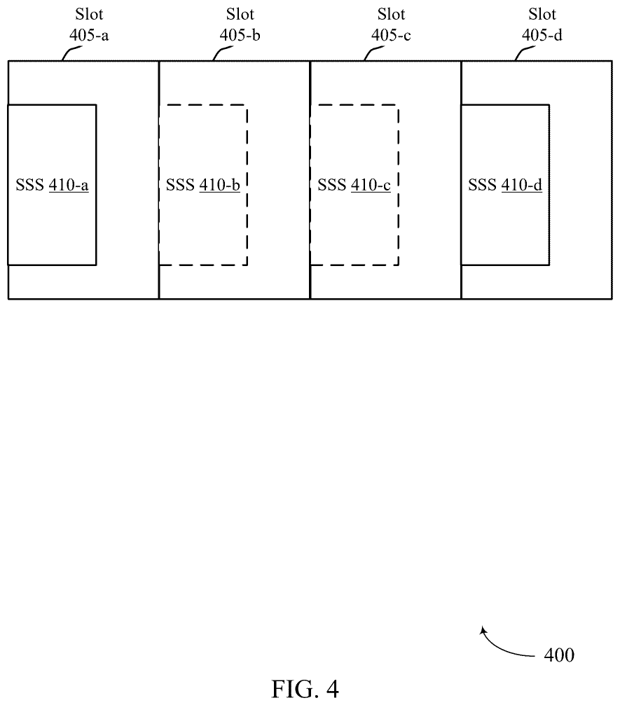

In some examples, the UE 115-a may adapt a configured SSS based on whether the UE 115-a monitors via the bandwidth portion 220-a or the bandwidth portion 220-b. For example, the UE 115-a may monitor a SSS more frequently when the UE 115-a monitors via the bandwidth portion 220-b as compared to when the UE 115-a monitors via the bandwidth portion 220-a. Such techniques are described in further detail with reference to FIG. 4.

FIGS. 3A and 3B show examples of a resource diagram 300-a and a resource diagram 300-b that supports configuring control resource sets for portions of bandwidth parts in accordance with one or more aspects of the present disclosure. The resource diagram 300-a and the resource diagram 300-b may implement or may be implemented by aspects of the wireless communications system 100 or the wireless communications system 200. For example, the resource diagram 300-a and the resource diagram 300-b may be implemented by a UE 115 or a network entity 105, which may be examples of the corresponding devices as described with reference to FIG. 1.

In some examples, as described with reference FIG. 2, a UE 115 may be configured to monitor for PDCCH messages via one or more monitoring occasions 310. The UE 115 receive a configuration from a network entity 105 for a bandwidth portion 305-a (e.g., a subBWP, a portion of an active BWP, one or more REs, one or more RBs) for one or more first slots and a bandwidth portion 305-b (e.g., the active BWP) for one or more second slots.

In some examples, a network entity 105 may configure the UE 115 with a superset of monitoring occasions 310. The UE 115 may select monitoring occasions 310 of the superset to monitor for PDCCH messages based on whether the UE 115 is configured to monitor via the bandwidth portion 305-a or the bandwidth portion 305-b. That is, the network entity 105 may preconfigure the UE 115 with a union of all monitoring occasions 310 based on both of the bandwidth portion 305-a and the bandwidth portion 305-b (e.g., a set of monitoring occasions 310 that are distributed according to a hashing based on the relatively more narrow bandwidth and a set of monitoring occasions 310 that are distributed according to a hashing based on the wide bandwidth).

The UE 115 may use a validity rule to determine whether a given monitoring occasion 310 is valid for a given bandwidth portion 305. For example, the network entity 105 may configure the UE 115 with a mask to apply to the configured superset of monitoring occasions 310. The mask may be a bitmap including a first value (e.g., 1) that indicates that a corresponding monitoring occasion 310 is valid and a second value (e.g., 0) that indicates that a corresponding monitoring occasion 310 is not valid. As an illustrative example, the network entity 105 may configure the UE 115 with a bitmap of values 1110 (e.g., a first mask) corresponding to the bandwidth portion 305-a that indicates that a monitoring occasion 310-a, a monitoring occasion 310-b, and a monitoring occasion 310-d are valid for the bandwidth portion 305-a and that a monitoring occasion 310-c is not valid for the bandwidth portion 305-a. The network entity 105 may configure the UE 115 with a bitmap of values 1101 (e.g., a second mask) corresponding to the bandwidth portion 305-b that indicates that a monitoring occasion 310-a, a monitoring occasion 310-b, and a monitoring occasion 310-c are valid for the bandwidth portion 305-a and that a monitoring occasion 310-d is not valid for the bandwidth portion 305-a.

In some examples, as illustrated with reference to the resource diagram 300-a, the UE 115 may not monitor the full superset of monitoring occasions 310 (e.g., such that a maximum quantity M of blind decoding candidates for the bandwidth portion 305-a is equal to a maximum quantity M of blind decoding candidates for the bandwidth portion 305-b). That is, the UE 115 may monitor a first subset of the monitoring occasions 310 (e.g., less than all of the monitoring occasions 310, such as the monitoring occasion 310-a, the monitoring occasion 310-b, and the monitoring occasion 310-d) when the UE 115 monitors via the bandwidth portion 305-a and a second subset of the monitoring occasions 310 (e.g., less than all of the monitoring occasions 310, such as the monitoring occasion 310-a, the monitoring occasion 310-b, and the monitoring occasion 310-c) when the UE 115 monitors via the bandwidth portion 305-b. In such examples, the configured masks may indicate that one or more monitoring occasions 310 are not valid for each bandwidth portion 305.

In some examples, the UE 115 may monitor the full superset of monitoring occasions when the UE 115 is configured to monitor for PDCCH messages via the bandwidth portion 305-b (e.g., such that a maximum quantity M of blind decoding candidates for the bandwidth portion 305-a is greater than a maximum quantity N of blind decoding candidates for the bandwidth portion 305-b). That is, the UE 115 may monitor a first subset of the monitoring occasions 310 (e.g., less than all of the monitoring occasions 310, such as the monitoring occasion 310-a, the monitoring occasion 310-b, and the monitoring occasion 310-d) when the UE 115 monitors via the bandwidth portion 305-a and all of the monitoring occasions 310 (e.g., the monitoring occasion 310-a, the monitoring occasion 310-b, the monitoring occasion 310-c, and the monitoring occasion 310-d) when the UE 115 monitors via the bandwidth portion 305-b. In such examples, the configured masks may indicate that one or more monitoring occasions 310 are not valid for the bandwidth portion 305-a and that all of the monitoring occasions 310 are valid for the bandwidth portion 305-b. For example, the network entity 105 may configure the UE 115 with a bitmap of values 1111 for the bandwidth portion 305-b.

FIG. 4 shows an example of a resource diagram 400 that supports configuring control resource sets for portions of bandwidth parts in accordance with one or more aspects of the present disclosure. The resource diagram 400 may implement or may be implemented by aspects of the wireless communications system 100 or the wireless communications system 200, the resource diagram 300-a, or the resource diagram 300-b. For example, the resource diagram 400 may be implemented by a UE 115 or a network entity 105, which may be examples of the corresponding devices as described with reference to FIG. 1.

In some examples, as described with reference to FIG. 2, a network entity 105 may configure a UE 115 to monitor for PDCCH messages via one or more SSSs 410. For example, the UE 115 may identify a SSS 410 in one or more slots 405. Each SSS 410 may include one or more monitoring occasions via which the UE 115 may monitor for downlink transmissions as described herein.

In some examples, the UE 115 may receive a configuration indicating for the UE 115 to communicate via one or more bandwidth portion. For example, the UE 115 may receive a configuration to monitor for downlink transmissions via a first bandwidth portion (e.g., an active BWP, a first set of RBs, a first set of RBGs, a first frequency subband allocation) during one or more first slots 405 and to monitor for downlink transmissions via a second bandwidth portion (e.g., a subset of the active BWP, a second set of RBs, a second set of RBGs, a second frequency subband allocation). The second bandwidth portion may overlap with the first bandwidth portion. For example, the second bandwidth portion may be a subset of the first bandwidth portion.

In some examples, the UE 115 may receive a same SSS configuration for all bandwidth portions of a bandwidth (e.g., the active BWP and the subBWP). However, the UE 115 may use a scheduling restriction to adapt the SSS configuration (e.g., to identify one or more SSSs 410 to monitor during one or more slots 405 depending on a bandwidth portion corresponding to the one or more slots 405). For example, the configuration may indicate for the UE 115 to monitor for downlink transmissions via a SSS 410-a, via a SSS 410-b, via a SSS 410-c, and via a SSS 410-d during a slot 405-a, a slot 405-b, a slot 405-c, and a slot 405-d, respectively. The scheduling restriction may indicate that, if the UE 115 is configured to operate via the second bandwidth portion, the UE 115 may not receive a downlink transmission (e.g., a PDCCH) via one or more slots 405 (e.g., every X slots).

As an illustrative example, if the UE 115 is configured to monitor for downlink transmissions via the first bandwidth portion, the UE 115 may monitor via all of the SSS 410-a, the SSS 410-b, the SSS 410-c, and the SSS 410-d (e.g., every slot 405). Additionally, or alternatively, if the UE 115 is configured to monitor for downlink transmissions via the second bandwidth portion, a same SSS configuration may apply, and the UE 115 may monitor via the SSS 410-a and the SSS 410-d, and may not monitor via the SSS 410-b, and the SSS 410-c (e.g., with a different periodicity or via every other slot 405, such as via the SSS 410-a and the SSS 410-c, and not via the SSS 410-b, and the SSS 410-d).

In some examples, the network entity 105 may indicate the scheduling restriction (e.g., UE behavior while monitoring via the second bandwidth portion) to the UE 115 via the bandwidth portion configuration (e.g., the configuration indicating one or more slots during which the UE 115 may monitor via the first bandwidth portion and one or more slots during which the UE 115 may monitor via the second bandwidth portion). For example, the network entity 105 may indicate a first SSS periodicity for the first bandwidth portion and a second SSS periodicity for the second bandwidth portion. In some examples, the scheduling restriction for SSSs 410 may be different from a SSS group (SSSG) adaptation.

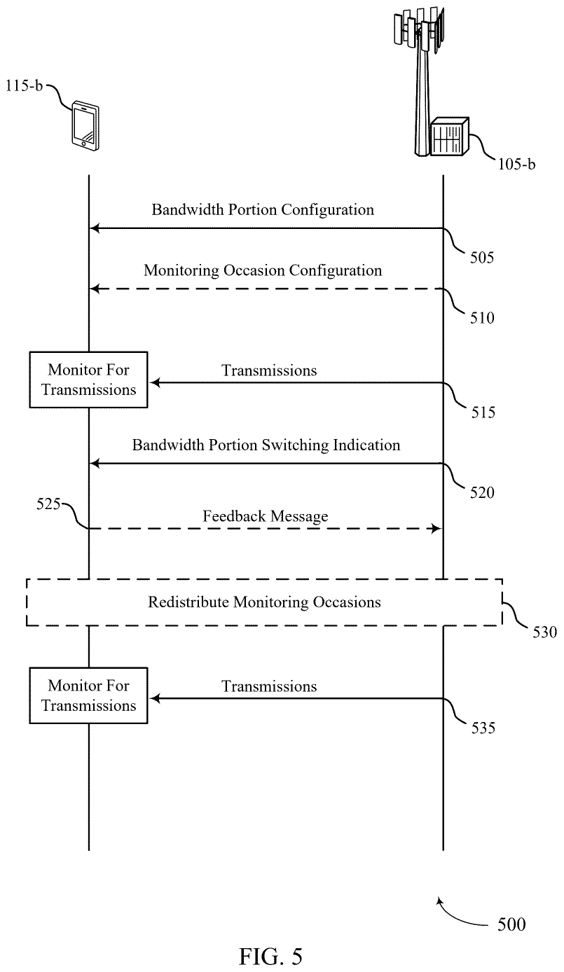

FIG. 5 shows an example of a process flow 500 that supports configuring control resource sets for portions of bandwidth parts in accordance with one or more aspects of the present disclosure. The process flow 500 may implement or may be implemented by aspects of the wireless communications system 100 or the wireless communications system 200, the resource diagram 300-a, the resource diagram 300-b, or the resource diagram 400. For example, the process flow 500 may be implemented by a UE 115 (e.g., a UE 115-b) or a network entity 105 (e.g., a network entity 105-b), which may be examples of the corresponding devices as described with reference to FIG. 1.

In the following description of the process flow 500, the operations between the UE 115-b and the network entity 105-b may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time.

At 505, the network entity 105-b may transmit control signaling to the UE 115-b indicating a bandwidth portion configuration. The bandwidth portion configuration may include a first bandwidth portion (e.g., an active BWP) and a second bandwidth portion that at least partially overlaps with the first portion (e.g., a subset of the active BWP, a subBWP). In some examples, the bandwidth portion configuration may include a monitoring occasion mask (e.g., a bitmap) indicating one or more valid monitoring occasions corresponding to each bandwidth portion. In some examples, the bandwidth portion configuration may include a SSS periodicity corresponding to each bandwidth portion.

In some examples, at 510, the UE 115-b may receive, from the network entity 105-b, control signaling indicating a set of monitoring occasions. In some examples, the set of monitoring occasions may include a superset of monitoring occasions associated with both of the first bandwidth portion and the second bandwidth position. Additionally, or alternatively, the set of monitoring occasions may include a set of monitoring occasions associated with the first bandwidth portion. In some examples, the UE 115-b and the network entity 105-b may compute one or more indices associated with the set of monitoring occasions (e.g., in addition to or instead of receiving the control signaling indicating the set of monitoring occasions).

At 515, the UE 115-b may monitor for one or more transmissions from the network entity 105-b via a first valid set of monitoring occasions (e.g., a subset of monitoring occasions of the set of monitoring occasions, all of the monitoring occasions of the set of monitoring occasions). In some examples, the UE 115-b and the network entity 105-b may select the first valid set of monitoring occasions from the set of monitoring occasions (e.g., in response to the bandwidth portion configuration). For example, the UE 115-b and the network entity 105-b may identify the first valid set of monitoring occasions based on a first monitoring occasion mask indicated via the bandwidth portion configuration. The UE 115-b may monitor the first valid set of monitoring occasions according to a first periodicity associated with the first bandwidth portion.

At 520, the UE 115-b may receive, from the network entity 105-b, an indication for the UE 115-b to switch from the first bandwidth portion to the second bandwidth portion. For example, the network entity 105-b may output an explicit indication for the UE 115-b to switch from the first bandwidth portion to the second bandwidth portion. Additionally, or alternatively, the network entity 105-b may configure the UE 115-b with one or more slots associated with the first bandwidth portion and one or more slots associated with the second bandwidth portion. In such examples, the UE 115-b may determine to switch to the second bandwidth portion based on communicating via the one or more slots associated with the second bandwidth portion. In some examples, at 525, the UE 115-b may transmit a feedback message to the network entity 105-b indicating an acknowledgement of switching to the second bandwidth portion.

In some examples, at 530, in response to the indication for the UE 115-b to switch from the first bandwidth portion to the second bandwidth portion, in response to the feedback message, or both, the UE 115-b and the network entity 105-b may select a second valid set of monitoring occasions from the set of monitoring occasions. For example, the UE 115-b and the network entity 105-b may identify the second valid set of monitoring occasions based on a second monitoring occasion mask indicated via the bandwidth portion configuration. Additionally, or alternatively, the UE 115-b and the network entity 105-b may redistribute one or more monitoring occasions (e.g., one or more monitoring occasions that fall outside of the second bandwidth portion) of the first valid set of monitoring occasions to generate the second valid set of monitoring occasions.

In some examples, the second valid set of monitoring occasions may include a subset of the first valid set of monitoring occasions. Additionally, or alternatively, the second valid set of monitoring occasions may one or more monitoring occasions different from the first valid set of monitoring occasions (e.g., and vice-versa). In some examples, prior to receiving the feedback message, the network entity 105-b may transmit via one or more monitoring occasions that are common between the first valid set of monitoring occasions and the second valid set of monitoring occasions.

At 535, the UE 115-b may monitor for one or more additional transmissions from the network entity 105-b via the second valid set of monitoring occasions. The UE 115-b may monitor the second valid set of monitoring occasions according to a second periodicity associated with the second bandwidth portion.

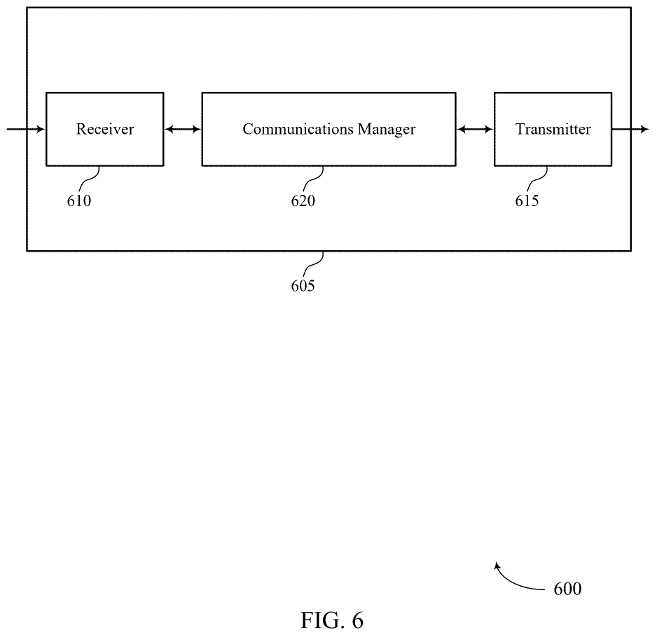

FIG. 6 shows a block diagram 600 of a device 605 that supports configuring control resource sets for portions of bandwidth parts in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to configuring control resource sets for portions of bandwidth parts). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configuring control resource sets for portions of bandwidth parts). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of configuring control resource sets for portions of bandwidth parts as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving first signaling indicating a configuration for a set of multiple portions of a bandwidth, the set of multiple portions of the bandwidth including a first portion of the bandwidth and a second portion of the bandwidth that at least partially overlaps with the first portion of the bandwidth. The communications manager 620 is capable of, configured to, or operable to support a means for receiving second signaling indicating configuration information associated with monitoring the first portion of the bandwidth and monitoring the second portion of the bandwidth. The communications manager 620 is capable of, configured to, or operable to support a means for monitoring for one or more first transmissions via the first portion of the bandwidth in a first valid set of monitoring occasions according to the configuration for the set of multiple portions of the bandwidth and according to the configuration information associated with monitoring the first portion of the bandwidth. The communications manager 620 is capable of, configured to, or operable to support a means for receiving third signaling indicating for the UE to operate in the second portion of the bandwidth. The communications manager 620 is capable of, configured to, or operable to support a means for monitoring for one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for adapting CORESETS for portions of bandwidths, which may result in more efficient utilization of communication resources.

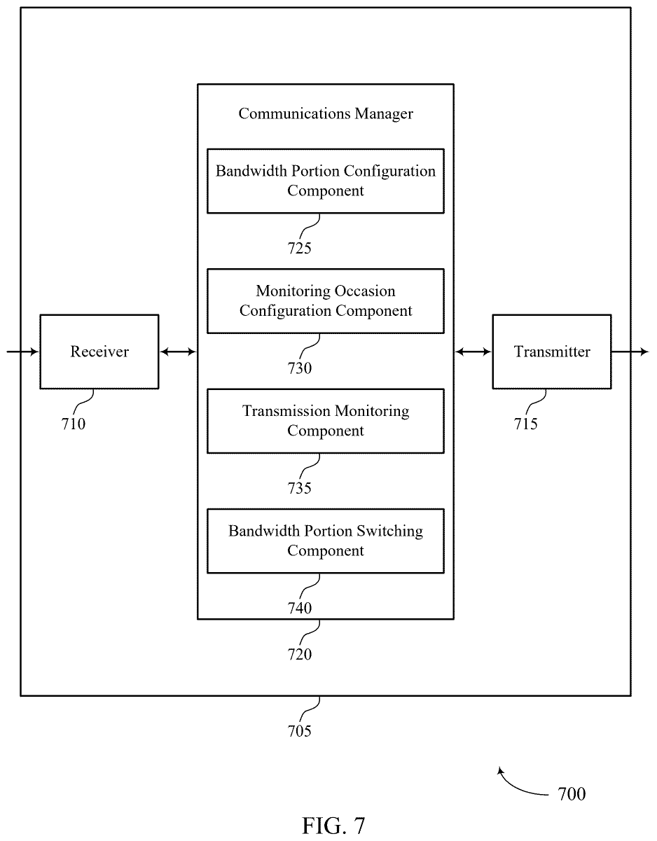

FIG. 7 shows a block diagram 700 of a device 705 that supports configuring control resource sets for portions of bandwidth parts in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to configuring control resource sets for portions of bandwidth parts). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to configuring control resource sets for portions of bandwidth parts). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of configuring control resource sets for portions of bandwidth parts as described herein. For example, the communications manager 720 may include a bandwidth portion configuration component 725, a monitoring occasion configuration component 730, a transmission monitoring component 735, a bandwidth portion switching component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The bandwidth portion configuration component 725 is capable of, configured to, or operable to support a means for receiving first signaling indicating a configuration for a set of multiple portions of a bandwidth, the set of multiple portions of the bandwidth including a first portion of the bandwidth and a second portion of the bandwidth that at least partially overlaps with the first portion of the bandwidth. The monitoring occasion configuration component 730 is capable of, configured to, or operable to support a means for receiving second signaling indicating configuration information associated with monitoring the first portion of the bandwidth and monitoring the second portion of the bandwidth. The transmission monitoring component 735 is capable of, configured to, or operable to support a means for monitoring for one or more first transmissions via the first portion of the bandwidth in a first valid set of monitoring occasions according to the configuration for the set of multiple portions of the bandwidth and according to the configuration information associated with monitoring the first portion of the bandwidth. The bandwidth portion switching component 740 is capable of, configured to, or operable to support a means for receiving third signaling indicating for the UE to operate in the second portion of the bandwidth. The transmission monitoring component 735 is capable of, configured to, or operable to support a means for monitoring for one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

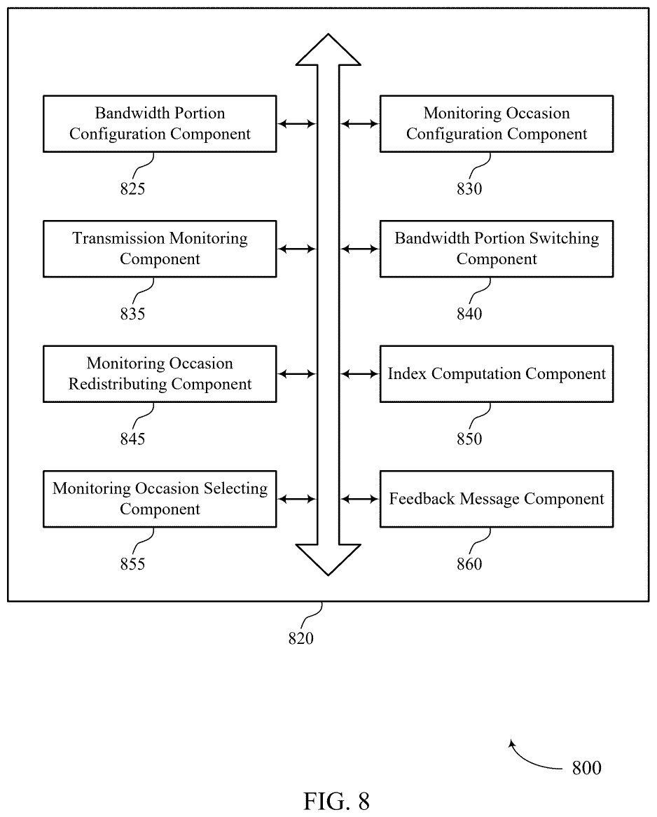

FIG. 8 shows a block diagram 800 of a communications manager 820 that supports configuring control resource sets for portions of bandwidth parts in accordance with one or more aspects of the present disclosure. The communications manager 820 may be an example of aspects of a communications manager 620, a communications manager 720, or both, as described herein. The communications manager 820, or various components thereof, may be an example of means for performing various aspects of configuring control resource sets for portions of bandwidth parts as described herein. For example, the communications manager 820 may include a bandwidth portion configuration component 825, a monitoring occasion configuration component 830, a transmission monitoring component 835, a bandwidth portion switching component 840, a monitoring occasion redistributing component 845, an index computation component 850, a monitoring occasion selecting component 855, a feedback message component 860, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The bandwidth portion configuration component 825 is capable of, configured to, or operable to support a means for receiving first signaling indicating a configuration for a set of multiple portions of a bandwidth, the set of multiple portions of the bandwidth including a first portion of the bandwidth and a second portion of the bandwidth that at least partially overlaps with the first portion of the bandwidth. The monitoring occasion configuration component 830 is capable of, configured to, or operable to support a means for receiving second signaling indicating configuration information associated with monitoring the first portion of the bandwidth and monitoring the second portion of the bandwidth. The transmission monitoring component 835 is capable of, configured to, or operable to support a means for monitoring for one or more first transmissions via the first portion of the bandwidth in a first valid set of monitoring occasions according to the configuration for the set of multiple portions of the bandwidth and according to the configuration information associated with monitoring the first portion of the bandwidth. The bandwidth portion switching component 840 is capable of, configured to, or operable to support a means for receiving third signaling indicating for the UE to operate in the second portion of the bandwidth. In some examples, the transmission monitoring component 835 is capable of, configured to, or operable to support a means for monitoring for one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

In some examples, the configuration information associated with monitoring indicates a set of monitoring occasions including the first valid set of monitoring occasions and the second valid set of monitoring occasions.

In some examples, the monitoring occasion selecting component 855 is capable of, configured to, or operable to support a means for selecting, in response to the first signaling, the first valid set of monitoring occasions. In some examples, the monitoring occasion selecting component 855 is capable of, configured to, or operable to support a means for selecting, in response to the second signaling, the second valid set of monitoring occasions.

In some examples, the monitoring occasion selecting component 855 is capable of, configured to, or operable to support a means for receiving, via the first signaling, a first monitoring occasion mask associated with the first portion of the bandwidth and a second monitoring occasion mask associated with the second portion of the bandwidth.

In some examples, the first monitoring occasion mask and the second monitoring occasion mask include bitmaps indicating whether one or more monitoring occasions of the set of monitoring occasions are valid.

In some examples, the configuration information associated with monitoring indicates the first valid set of monitoring occasions.

In some examples, the configuration information associated with monitoring indicates the second valid set of monitoring occasions.

In some examples, the second valid set of monitoring occasions excludes one or more valid monitoring occasions of the first valid set of monitoring occasions based on the one or more valid monitoring occasions of the first valid set of monitoring occasions being located outside of the second portion of the bandwidth.

In some examples, the monitoring occasion redistributing component 845 is capable of, configured to, or operable to support a means for redistributing one or more valid monitoring occasions of the first valid set of monitoring occasions to be within the second portion of the bandwidth based on the one or more valid monitoring occasions of the first valid set of monitoring occasions being located outside of the second portion of the bandwidth.

In some examples, the index computation component 850 is capable of, configured to, or operable to support a means for computing one or more indices associated with a set of monitoring occasions, the set of monitoring occasions including the first valid set of monitoring occasions and the second valid set of monitoring occasions. In some examples, the monitoring occasion selecting component 855 is capable of, configured to, or operable to support a means for selecting, in response to the first signaling, the first valid set of monitoring occasions. In some examples, the monitoring occasion selecting component 855 is capable of, configured to, or operable to support a means for selecting, in response to the second signaling, the second valid set of monitoring occasions.

In some examples, the first valid set of monitoring occasions includes at least one monitoring occasion of the second valid set of monitoring occasions.

In some examples, the first valid set of monitoring occasions excludes one or more monitoring occasions of the second valid set of monitoring occasions.

In some examples, the transmission monitoring component 835 is capable of, configured to, or operable to support a means for monitoring the first valid set of monitoring occasions via a first search space set associated with a first periodicity. In some examples, the transmission monitoring component 835 is capable of, configured to, or operable to support a means for monitoring the second valid set of monitoring occasions via a second search space set associated with a second periodicity.

In some examples, the feedback message component 860 is capable of, configured to, or operable to support a means for transmitting a feedback message in response to the second signaling, the feedback message including an indication of the second portion of the bandwidth.

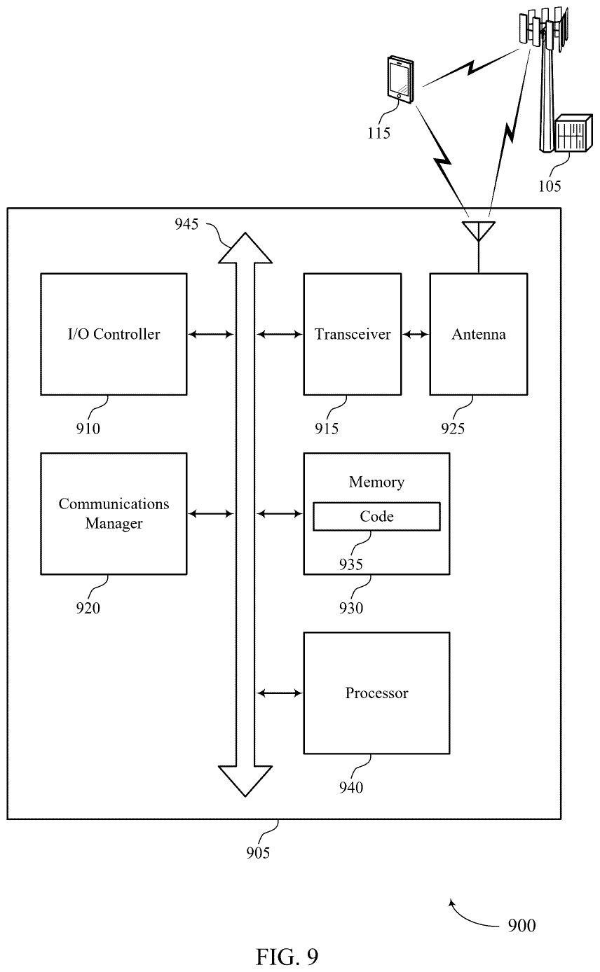

FIG. 9 shows a diagram of a system 900 including a device 905 that supports configuring control resource sets for portions of bandwidth parts in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting configuring control resource sets for portions of bandwidth parts). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving first signaling indicating a configuration for a set of multiple portions of a bandwidth, the set of multiple portions of the bandwidth including a first portion of the bandwidth and a second portion of the bandwidth that at least partially overlaps with the first portion of the bandwidth. The communications manager 920 is capable of, configured to, or operable to support a means for receiving second signaling indicating configuration information associated with monitoring the first portion of the bandwidth and monitoring the second portion of the bandwidth. The communications manager 920 is capable of, configured to, or operable to support a means for monitoring for one or more first transmissions via the first portion of the bandwidth in a first valid set of monitoring occasions according to the configuration for the set of multiple portions of the bandwidth and according to the configuration information associated with monitoring the first portion of the bandwidth. The communications manager 920 is capable of, configured to, or operable to support a means for receiving third signaling indicating for the UE to operate in the second portion of the bandwidth. The communications manager 920 is capable of, configured to, or operable to support a means for monitoring for one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

By including or configuring the communications manager 920 in accordance with examples as described herein, the device 905 may support techniques for adapting CORESETS for portions of bandwidths, which may result in improved communication reliability, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of configuring control resource sets for portions of bandwidth parts as described herein, or the at least one processor 940 and the at least one memory 930 may be otherwise configured to, individually or collectively, perform or support such operations.

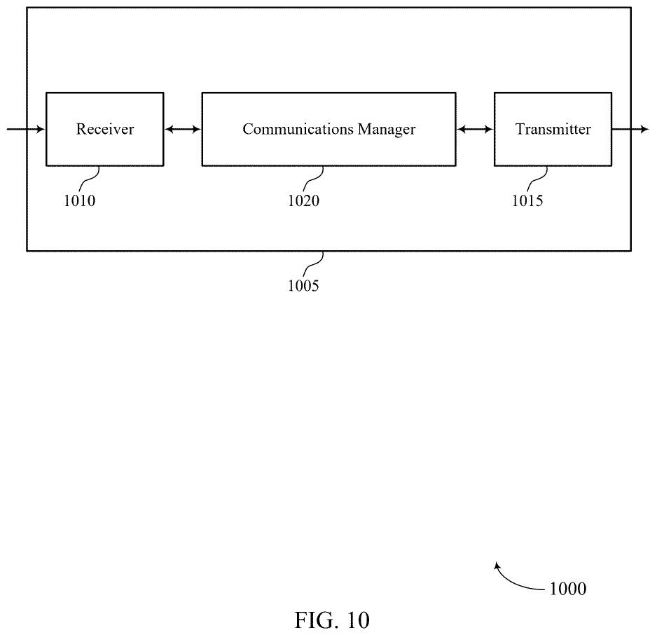

FIG. 10 shows a block diagram 1000 of a device 1005 that supports configuring control resource sets for portions of bandwidth parts in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of configuring control resource sets for portions of bandwidth parts as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for outputting first signaling indicating a configuration for a set of multiple portions of a bandwidth, the set of multiple portions of the bandwidth including a first portion of the bandwidth and a second portion of the bandwidth that at least partially overlaps with the first portion of the bandwidth. The communications manager 1020 is capable of, configured to, or operable to support a means for outputting second signaling indicating configuration information associated with monitoring the first portion of the bandwidth and monitoring the second portion of the bandwidth. The communications manager 1020 is capable of, configured to, or operable to support a means for outputting, to a UE, one or more first transmissions via the first portion of the bandwidth in a first valid set of monitoring occasions according to the configuration for the set of multiple portions of the bandwidth and according to the configuration information associated with monitoring the first portion of the bandwidth. The communications manager 1020 is capable of, configured to, or operable to support a means for outputting third signaling indicating for the UE to operate in the second portion of the bandwidth. The communications manager 1020 is capable of, configured to, or operable to support a means for outputting one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for adapting CORESETS for portions of bandwidths, which may result in more efficient utilization of communication resources.

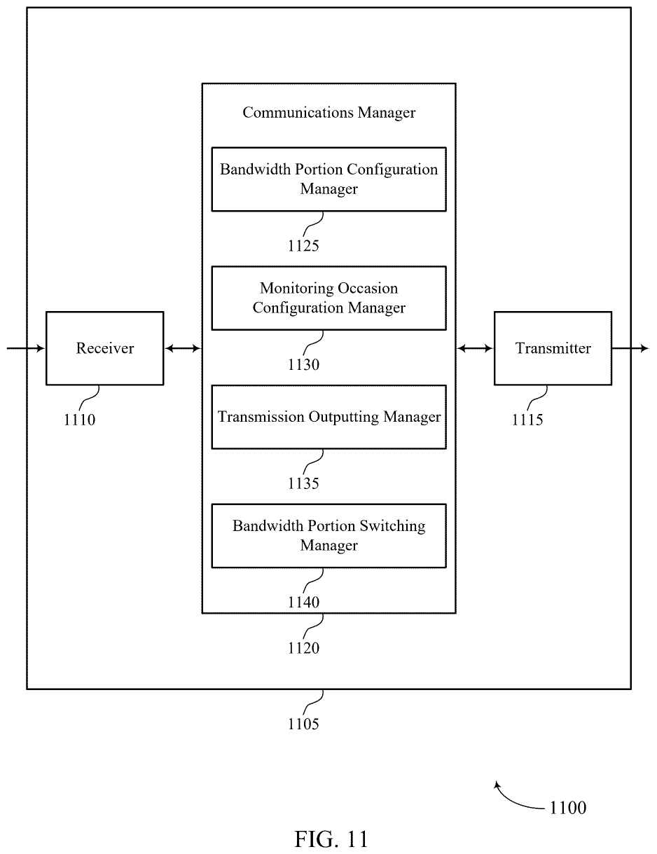

FIG. 11 shows a block diagram 1100 of a device 1105 that supports configuring control resource sets for portions of bandwidth parts in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of configuring control resource sets for portions of bandwidth parts as described herein. For example, the communications manager 1120 may include a bandwidth portion configuration manager 1125, a monitoring occasion configuration manager 1130, a transmission outputting manager 1135, a bandwidth portion switching manager 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The bandwidth portion configuration manager 1125 is capable of, configured to, or operable to support a means for outputting first signaling indicating a configuration for a set of multiple portions of a bandwidth, the set of multiple portions of the bandwidth including a first portion of the bandwidth and a second portion of the bandwidth that at least partially overlaps with the first portion of the bandwidth. The monitoring occasion configuration manager 1130 is capable of, configured to, or operable to support a means for outputting second signaling indicating configuration information associated with monitoring the first portion of the bandwidth and monitoring the second portion of the bandwidth. The transmission outputting manager 1135 is capable of, configured to, or operable to support a means for outputting, to a UE, one or more first transmissions via the first portion of the bandwidth in a first valid set of monitoring occasions according to the configuration for the set of multiple portions of the bandwidth and according to the configuration information associated with monitoring the first portion of the bandwidth. The bandwidth portion switching manager 1140 is capable of, configured to, or operable to support a means for outputting third signaling indicating for the UE to operate in the second portion of the bandwidth. The transmission outputting manager 1135 is capable of, configured to, or operable to support a means for outputting one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

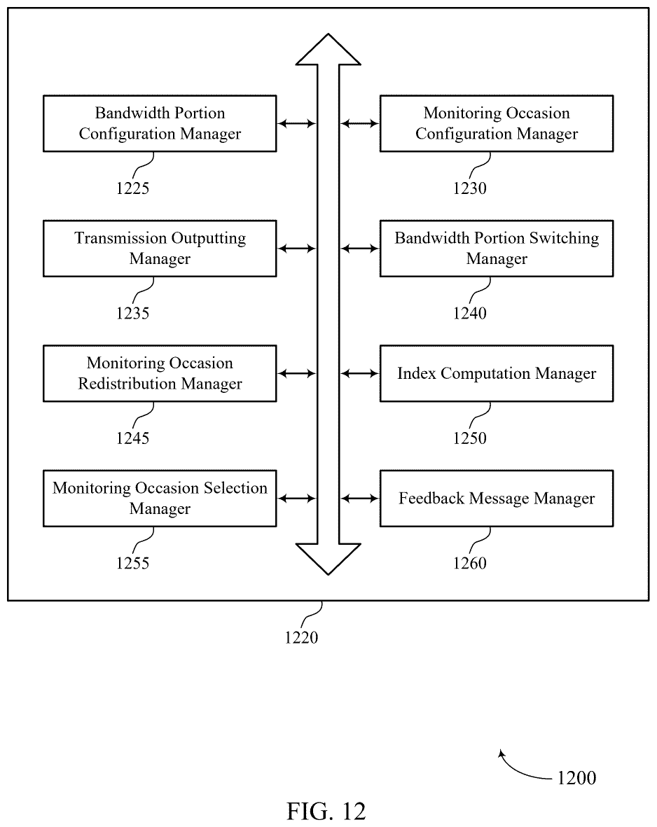

FIG. 12 shows a block diagram 1200 of a communications manager 1220 that supports configuring control resource sets for portions of bandwidth parts in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of configuring control resource sets for portions of bandwidth parts as described herein. For example, the communications manager 1220 may include a bandwidth portion configuration manager 1225, a monitoring occasion configuration manager 1230, a transmission outputting manager 1235, a bandwidth portion switching manager 1240, a monitoring occasion redistribution manager 1245, an index computation manager 1250, a monitoring occasion selection manager 1255, a feedback message manager 1260, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The bandwidth portion configuration manager 1225 is capable of, configured to, or operable to support a means for outputting first signaling indicating a configuration for a set of multiple portions of a bandwidth, the set of multiple portions of the bandwidth including a first portion of the bandwidth and a second portion of the bandwidth that at least partially overlaps with the first portion of the bandwidth. The monitoring occasion configuration manager 1230 is capable of, configured to, or operable to support a means for outputting second signaling indicating configuration information associated with monitoring the first portion of the bandwidth and monitoring the second portion of the bandwidth. The transmission outputting manager 1235 is capable of, configured to, or operable to support a means for outputting, to a UE, one or more first transmissions via the first portion of the bandwidth in a first valid set of monitoring occasions according to the configuration for the set of multiple portions of the bandwidth and according to the configuration information associated with monitoring the first portion of the bandwidth. The bandwidth portion switching manager 1240 is capable of, configured to, or operable to support a means for outputting third signaling indicating for the UE to operate in the second portion of the bandwidth. In some examples, the transmission outputting manager 1235 is capable of, configured to, or operable to support a means for outputting one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

In some examples, the configuration information associated with monitoring indicates a set of monitoring occasions including the first valid set of monitoring occasions and the second valid set of monitoring occasions.

In some examples, the monitoring occasion selection manager 1255 is capable of, configured to, or operable to support a means for selecting, in response to the first signaling, the first valid set of monitoring occasions. In some examples, the monitoring occasion selection manager 1255 is capable of, configured to, or operable to support a means for selecting, in response to the second signaling, the second valid set of monitoring occasions.

In some examples, the monitoring occasion selection manager 1255 is capable of, configured to, or operable to support a means for outputting, via the first signaling, a first monitoring occasion mask associated with the first portion of the bandwidth and a second monitoring occasion mask associated with the second portion of the bandwidth.

In some examples, the first monitoring occasion mask and the second monitoring occasion mask include bitmaps indicating whether one or more monitoring occasions of the set of monitoring occasions are valid.

In some examples, the configuration information associated with monitoring indicates the first valid set of monitoring occasions.

In some examples, the configuration information associated with monitoring indicates the second valid set of monitoring occasions.

In some examples, the second valid set of monitoring occasions excludes one or more valid monitoring occasions of the first valid set of monitoring occasions based on the one or more valid monitoring occasions of the first valid set of monitoring occasions being located outside of the second portion of the bandwidth.

In some examples, the monitoring occasion redistribution manager 1245 is capable of, configured to, or operable to support a means for redistributing one or more valid monitoring occasions of the first valid set of monitoring occasions to be within the second portion of the bandwidth based on the one or more valid monitoring occasions of the first valid set of monitoring occasions being located outside of the second portion of the bandwidth.

In some examples, the index computation manager 1250 is capable of, configured to, or operable to support a means for computing one or more indices associated with a set of monitoring occasions, the set of monitoring occasions including the first valid set of monitoring occasions and the second valid set of monitoring occasions. In some examples, the monitoring occasion selection manager 1255 is capable of, configured to, or operable to support a means for selecting, in response to the first signaling, the first valid set of monitoring occasions. In some examples, the monitoring occasion selection manager 1255 is capable of, configured to, or operable to support a means for selecting, in response to the second signaling, the second valid set of monitoring occasions.

In some examples, the first valid set of monitoring occasions includes at least one monitoring occasion of the second valid set of monitoring occasions.

In some examples, the first valid set of monitoring occasions excludes one or more monitoring occasions of the second valid set of monitoring occasions.

In some examples, the transmission outputting manager 1235 is capable of, configured to, or operable to support a means for outputting the one or more first transmissions via a first search space set associated with a first periodicity. In some examples, the transmission outputting manager 1235 is capable of, configured to, or operable to support a means for outputting the one or more second transmissions via a second search space set associated with a second periodicity.

In some examples, the feedback message manager 1260 is capable of, configured to, or operable to support a means for receiving a feedback message in response to the second signaling, the feedback message including an indication of the second portion of the bandwidth, where outputting the one or more second transmissions via the second valid set of monitoring occasions is based on receiving the feedback message.

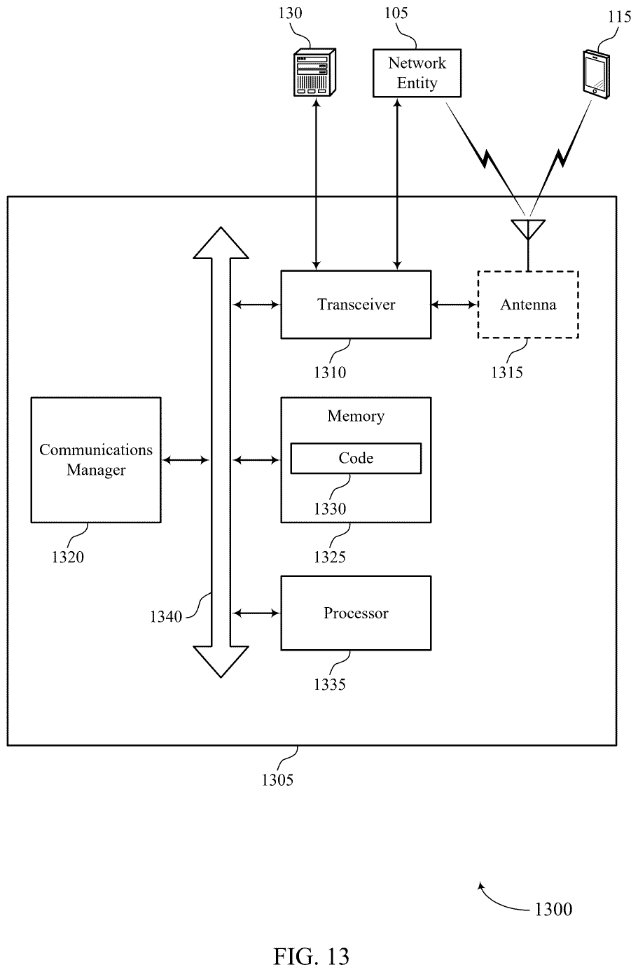

FIG. 13 shows a diagram of a system 1300 including a device 1305 that supports configuring control resource sets for portions of bandwidth parts in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting configuring control resource sets for portions of bandwidth parts). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for outputting first signaling indicating a configuration for a set of multiple portions of a bandwidth, the set of multiple portions of the bandwidth including a first portion of the bandwidth and a second portion of the bandwidth that at least partially overlaps with the first portion of the bandwidth. The communications manager 1320 is capable of, configured to, or operable to support a means for outputting second signaling indicating configuration information associated with monitoring the first portion of the bandwidth and monitoring the second portion of the bandwidth. The communications manager 1320 is capable of, configured to, or operable to support a means for outputting, to a UE, one or more first transmissions via the first portion of the bandwidth in a first valid set of monitoring occasions according to the configuration for the set of multiple portions of the bandwidth and according to the configuration information associated with monitoring the first portion of the bandwidth. The communications manager 1320 is capable of, configured to, or operable to support a means for outputting third signaling indicating for the UE to operate in the second portion of the bandwidth. The communications manager 1320 is capable of, configured to, or operable to support a means for outputting one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same.

By including or configuring the communications manager 1320 in accordance with examples as described herein, the device 1305 may support techniques for adapting CORESETS for portions of bandwidths, which may result in improved communication reliability, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of configuring control resource sets for portions of bandwidth parts as described herein, or the at least one processor 1335 and the at least one memory 1325 may be otherwise configured to, individually or collectively, perform or support such operations.

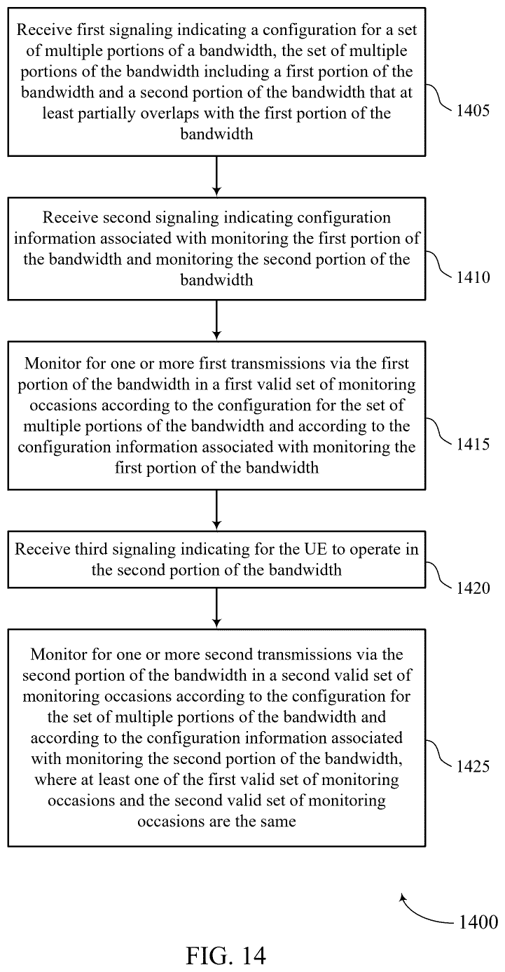

FIG. 14 shows a flowchart illustrating a method 1400 that supports configuring control resource sets for portions of bandwidth parts in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first signaling indicating a configuration for a set of multiple portions of a bandwidth, the set of multiple portions of the bandwidth including a first portion of the bandwidth and a second portion of the bandwidth that at least partially overlaps with the first portion of the bandwidth. The operations of 1405 may be performed in accordance with examples as disclosed herein. In some examples, aspects of the operations of 1405 may be performed by a bandwidth portion configuration component 825 as described with reference to FIG. 8.

At 1410, the method may include receiving second signaling indicating configuration information associated with monitoring the first portion of the bandwidth and monitoring the second portion of the bandwidth. The operations of 1410 may be performed in accordance with examples as disclosed herein. In some examples, aspects of the operations of 1410 may be performed by a monitoring occasion configuration component 830 as described with reference to FIG. 8.

At 1415, the method may include monitoring for one or more first transmissions via the first portion of the bandwidth in a first valid set of monitoring occasions according to the configuration for the set of multiple portions of the bandwidth and according to the configuration information associated with monitoring the first portion of the bandwidth. The operations of 1415 may be performed in accordance with examples as disclosed herein. In some examples, aspects of the operations of 1415 may be performed by a transmission monitoring component 835 as described with reference to FIG. 8.

At 1420, the method may include receiving third signaling indicating for the UE to operate in the second portion of the bandwidth. The operations of 1420 may be performed in accordance with examples as disclosed herein. In some examples, aspects of the operations of 1420 may be performed by a bandwidth portion switching component 840 as described with reference to FIG. 8.

At 1425, the method may include monitoring for one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same. The operations of 1425 may be performed in accordance with examples as disclosed herein. In some examples, aspects of the operations of 1425 may be performed by a transmission monitoring component 835 as described with reference to FIG. 8.

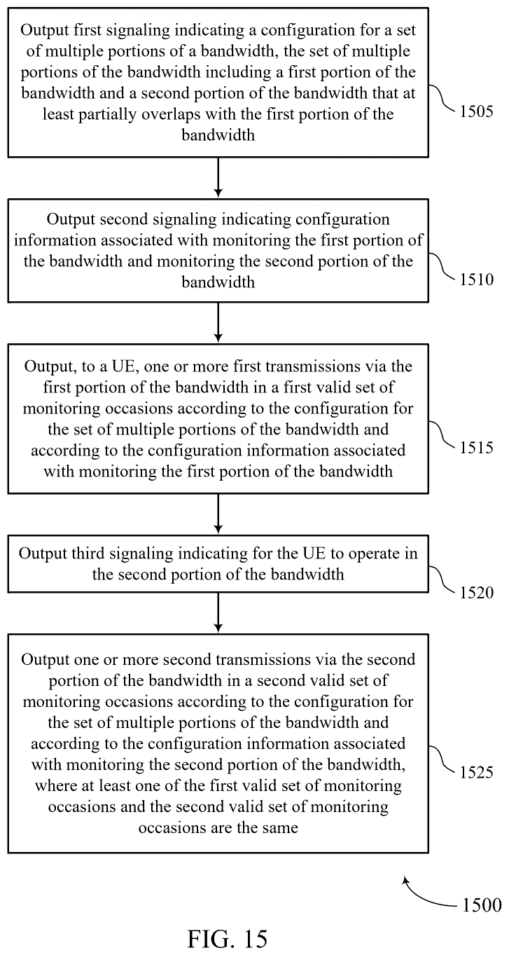

FIG. 15 shows a flowchart illustrating a method 1500 that supports configuring control resource sets for portions of bandwidth parts in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting first signaling indicating a configuration for a set of multiple portions of a bandwidth, the set of multiple portions of the bandwidth including a first portion of the bandwidth and a second portion of the bandwidth that at least partially overlaps with the first portion of the bandwidth. The operations of 1505 may be performed in accordance with examples as disclosed herein. In some examples, aspects of the operations of 1505 may be performed by a bandwidth portion configuration manager 1225 as described with reference to FIG. 12.

At 1510, the method may include outputting second signaling indicating configuration information associated with monitoring the first portion of the bandwidth and monitoring the second portion of the bandwidth. The operations of 1510 may be performed in accordance with examples as disclosed herein. In some examples, aspects of the operations of 1510 may be performed by a monitoring occasion configuration manager 1230 as described with reference to FIG. 12.

At 1515, the method may include outputting, to a UE, one or more first transmissions via the first portion of the bandwidth in a first valid set of monitoring occasions according to the configuration for the set of multiple portions of the bandwidth and according to the configuration information associated with monitoring the first portion of the bandwidth. The operations of 1515 may be performed in accordance with examples as disclosed herein. In some examples, aspects of the operations of 1515 may be performed by a transmission outputting manager 1235 as described with reference to FIG. 12.

At 1520, the method may include outputting third signaling indicating for the UE to operate in the second portion of the bandwidth. The operations of 1520 may be performed in accordance with examples as disclosed herein. In some examples, aspects of the operations of 1520 may be performed by a bandwidth portion switching manager 1240 as described with reference to FIG. 12.

At 1525, the method may include outputting one or more second transmissions via the second portion of the bandwidth in a second valid set of monitoring occasions according to the configuration for the set of multiple portions of the bandwidth and according to the configuration information associated with monitoring the second portion of the bandwidth, where at least one of the first valid set of monitoring occasions and the second valid set of monitoring occasions are the same. The operations of 1525 may be performed in accordance with examples as disclosed herein. In some examples, aspects of the operations of 1525 may be performed by a transmission outputting manager 1235 as described with reference to FIG. 12.

The following provides an overview of aspects of the present disclosure:
Aspect 1: A method for wireless communication by a UE, comprising: receiving first signaling indicating a configuration for a plurality of portions of a bandwidth, the plurality of portions of the bandwidth comprising a first portion of the bandwidth and a second portion of the bandwidth that at least partially overlaps with the first portion of the bandwidth; receiving second signaling indicating configuration information associated with monitoring the first portion of the bandwidth and monitoring the second portion of the bandwidth; monitoring for one or more first transmissions via the first portion of the bandwidth in a first valid set of monitoring occasions according to the configuration for the plurality of portions of the bandwidth and according to the configuration information associated with monitoring the first portion of the bandwidth; receiving third signaling indicating for the UE to operate in the second portion of the bandwidth; and monitoring for one or more second transmissions via the second portion of the bandwidth in a second valid set of monitoring occasions according to the configuration for the plurality of portions of the bandwidth and according to the configuration information associated with monitoring the second portion of the bandwidth, wherein at least one of the first valid set of monitoring occasions and the second valid set of monitoring occasions are the same.
Aspect 2: The method of aspect 1, wherein the configuration information associated with monitoring indicates a set of monitoring occasions comprising the first valid set of monitoring occasions and the second valid set of monitoring occasions.
Aspect 3: The method of aspect 2, further comprising: selecting, in response to the first signaling, the first valid set of monitoring occasions; and selecting, in response to the second signaling, the second valid set of monitoring occasions.
Aspect 4: The method of any of aspects 2 through 3, further comprising: receiving, via the first signaling, a first monitoring occasion mask associated with the first portion of the bandwidth and a second monitoring occasion mask associated with the second portion of the bandwidth.
Aspect 5: The method of aspect 4, wherein the first monitoring occasion mask and the second monitoring occasion mask comprise bitmaps indicating whether one or more monitoring occasions of the set of monitoring occasions are valid.
Aspect 6: The method of any of aspects 1 through 5, wherein the configuration information associated with monitoring indicates the first valid set of monitoring occasions.
Aspect 7: The method of any of aspects 1 through 6, wherein the configuration information associated with monitoring indicates the second valid set of monitoring occasions.
Aspect 8: The method of any of aspects 1 through 7, wherein the second valid set of monitoring occasions excludes one or more valid monitoring occasions of the first valid set of monitoring occasions based at least in part on the one or more valid monitoring occasions of the first valid set of monitoring occasions being located outside of the second portion of the bandwidth.
Aspect 9: The method of any of aspects 1 through 8, further comprising: redistributing one or more valid monitoring occasions of the first valid set of monitoring occasions to be within the second portion of the bandwidth based at least in part on the one or more valid monitoring occasions of the first valid set of monitoring occasions being located outside of the second portion of the bandwidth.
Aspect 10: The method of any of aspects 1 through 9, further comprising: computing one or more indices associated with a set of monitoring occasions, the set of monitoring occasions comprising the first valid set of monitoring occasions and the second valid set of monitoring occasions; selecting, in response to the first signaling, the first valid set of monitoring occasions; and selecting, in response to the second signaling, the second valid set of monitoring occasions.
Aspect 11: The method of any of aspects 1 through 10, wherein the first valid set of monitoring occasions comprises at least one monitoring occasion of the second valid set of monitoring occasions.
Aspect 12: The method of any of aspects 1 through 11, wherein the first valid set of monitoring occasions excludes one or more monitoring occasions of the second valid set of monitoring occasions.
Aspect 13: The method of any of aspects 1 through 12, further comprising: monitoring the first valid set of monitoring occasions via a first search space set associated with a first periodicity; and monitoring the second valid set of monitoring occasions via a second search space set associated with a second periodicity.
Aspect 14: The method of any of aspects 1 through 13, further comprising: transmitting a feedback message in response to the second signaling, the feedback message comprising an indication of the second portion of the bandwidth.
Aspect 15: A method for wireless communication by a network entity, comprising: outputting first signaling indicating a configuration for a plurality of portions of a bandwidth, the plurality of portions of the bandwidth comprising a first portion of the bandwidth and a second portion of the bandwidth that at least partially overlaps with the first portion of the bandwidth; outputting second signaling indicating configuration information associated with monitoring the first portion of the bandwidth and monitoring the second portion of the bandwidth; outputting, to a UE, one or more first transmissions via the first portion of the bandwidth in a first valid set of monitoring occasions according to the configuration for the plurality of portions of the bandwidth and according to the configuration information associated with monitoring the first portion of the bandwidth; outputting third signaling indicating for the UE to operate in the second portion of the bandwidth; and outputting one or more second transmissions via the second portion of the bandwidth in a second valid set of monitoring occasions according to the configuration for the plurality of portions of the bandwidth and according to the configuration information associated with monitoring the second portion of the bandwidth, wherein at least one of the first valid set of monitoring occasions and the second valid set of monitoring occasions are the same.
Aspect 16: The method of aspect 15, wherein the configuration information associated with monitoring indicates a set of monitoring occasions comprising the first valid set of monitoring occasions and the second valid set of monitoring occasions.
Aspect 17: The method of aspect 16, further comprising: selecting, in response to the first signaling, the first valid set of monitoring occasions; and selecting, in response to the second signaling, the second valid set of monitoring occasions.
Aspect 18: The method of any of aspects 16 through 17, further comprising: outputting, via the first signaling, a first monitoring occasion mask associated with the first portion of the bandwidth and a second monitoring occasion mask associated with the second portion of the bandwidth.
Aspect 19: The method of aspect 18, wherein the first monitoring occasion mask and the second monitoring occasion mask comprise bitmaps indicating whether one or more monitoring occasions of the set of monitoring occasions are valid.
Aspect 20: The method of any of aspects 15 through 19, wherein the configuration information associated with monitoring indicates the first valid set of monitoring occasions.
Aspect 21: The method of any of aspects 15 through 20, wherein the configuration information associated with monitoring indicates the second valid set of monitoring occasions.
Aspect 22: The method of any of aspects 15 through 21, wherein the second valid set of monitoring occasions excludes one or more valid monitoring occasions of the first valid set of monitoring occasions based at least in part on the one or more valid monitoring occasions of the first valid set of monitoring occasions being located outside of the second portion of the bandwidth.
Aspect 23: The method of any of aspects 15 through 22, further comprising: redistributing one or more valid monitoring occasions of the first valid set of monitoring occasions to be within the second portion of the bandwidth based at least in part on the one or more valid monitoring occasions of the first valid set of monitoring occasions being located outside of the second portion of the bandwidth.
Aspect 24: The method of any of aspects 15 through 23, further comprising: computing one or more indices associated with a set of monitoring occasions, the set of monitoring occasions comprising the first valid set of monitoring occasions and the second valid set of monitoring occasions; selecting, in response to the first signaling, the first valid set of monitoring occasions; and selecting, in response to the second signaling, the second valid set of monitoring occasions.
Aspect 25: The method of any of aspects 15 through 24, wherein the first valid set of monitoring occasions comprises at least one monitoring occasion of the second valid set of monitoring occasions.
Aspect 26: The method of any of aspects 15 through 25, wherein the first valid set of monitoring occasions excludes one or more monitoring occasions of the second valid set of monitoring occasions.
Aspect 27: The method of any of aspects 15 through 26, further comprising: outputting the one or more first transmissions via a first search space set associated with a first periodicity; and outputting the one or more second transmissions via a second search space set associated with a second periodicity.
Aspect 28: The method of any of aspects 15 through 27, further comprising: receiving a feedback message in response to the second signaling, the feedback message comprising an indication of the second portion of the bandwidth, wherein outputting the one or more second transmissions via the second valid set of monitoring occasions is based at least in part on receiving the feedback message.
Aspect 29: A UE for wireless communication, comprising one or more memories storing processor-executable code, and one or more processors coupled with the one or more memories and individually or collectively operable to execute the code to cause the UE to perform a method of any of aspects 1 through 14.
Aspect 30: A UE for wireless communication, comprising at least one means for performing a method of any of aspects 1 through 14.
Aspect 31: A non-transitory computer-readable medium storing code for wireless communication, the code comprising instructions executable by one or more processors to perform a method of any of aspects 1 through 14.
Aspect 32: A network entity for wireless communication, comprising one or more memories storing processor-executable code, and one or more processors coupled with the one or more memories and individually or collectively operable to execute the code to cause the network entity to perform a method of any of aspects 15 through 28.
Aspect 33: A network entity for wireless communication, comprising at least one means for performing a method of any of aspects 15 through 28.
Aspect 34: A non-transitory computer-readable medium storing code for wireless communication, the code comprising instructions executable by one or more processors to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first signaling indicating a configuration for a plurality of portions of a bandwidth, the plurality of portions of the bandwidth comprising a first portion of the bandwidth and a second portion of the bandwidth that at least partially overlaps with the first portion of the bandwidth;
receive second signaling indicating configuration information associated with monitoring the first portion of the bandwidth and monitoring the second portion of the bandwidth;
monitor for one or more first transmissions via the first portion of the bandwidth in a first valid set of monitoring occasions according to the configuration for the plurality of portions of the bandwidth and according to the configuration information associated with monitoring the first portion of the bandwidth;
receive third signaling indicating for the UE to operate in the second portion of the bandwidth; and
monitor for one or more second transmissions via the second portion of the bandwidth in a second valid set of monitoring occasions according to the configuration for the plurality of portions of the bandwidth and according to the configuration information associated with monitoring the second portion of the bandwidth, wherein at least one of the first valid set of monitoring occasions and the second valid set of monitoring occasions are the same.

2. The UE of claim 1, wherein the configuration information associated with monitoring indicates a set of monitoring occasions comprising the first valid set of monitoring occasions and the second valid set of monitoring occasions.

3. The UE of claim 2, wherein the one or more processors are individually or collectively further operable to execute the code to cause the UE to:
select, in response to the first signaling, the first valid set of monitoring occasions; and
select, in response to the second signaling, the second valid set of monitoring occasions.

4. The UE of claim 2, wherein the one or more processors are individually or collectively further operable to execute the code to cause the UE to:
receive, via the first signaling, a first monitoring occasion mask associated with the first portion of the bandwidth and a second monitoring occasion mask associated with the second portion of the bandwidth.

5. The UE of claim 4, wherein the first monitoring occasion mask and the second monitoring occasion mask comprise bitmaps indicating whether one or more monitoring occasions of the set of monitoring occasions are valid.

6. The UE of claim 1, wherein the configuration information associated with monitoring indicates the first valid set of monitoring occasions.

7. The UE of claim 1, wherein the configuration information associated with monitoring indicates the second valid set of monitoring occasions.

8. The UE of claim 1, wherein the second valid set of monitoring occasions excludes one or more valid monitoring occasions of the first valid set of monitoring occasions based at least in part on the one or more valid monitoring occasions of the first valid set of monitoring occasions being located outside of the second portion of the bandwidth.

9. The UE of claim 1, wherein the one or more processors are individually or collectively further operable to execute the code to cause the UE to:
redistribute one or more valid monitoring occasions of the first valid set of monitoring occasions to be within the second portion of the bandwidth based at least in part on the one or more valid monitoring occasions of the first valid set of monitoring occasions being located outside of the second portion of the bandwidth.

10. The UE of claim 1, wherein the one or more processors are individually or collectively further operable to execute the code to cause the UE to:
compute one or more indices associated with a set of monitoring occasions, the set of monitoring occasions comprising the first valid set of monitoring occasions and the second valid set of monitoring occasions;
select, in response to the first signaling, the first valid set of monitoring occasions; and
select, in response to the second signaling, the second valid set of monitoring occasions.

11. The UE of claim 1, wherein the first valid set of monitoring occasions comprises at least one monitoring occasion of the second valid set of monitoring occasions.

12. The UE of claim 1, wherein the first valid set of monitoring occasions excludes one or more monitoring occasions of the second valid set of monitoring occasions.

13. The UE of claim 1, wherein the one or more processors are individually or collectively further operable to execute the code to cause the UE to:
monitor the first valid set of monitoring occasions via a first search space set associated with a first periodicity; and
monitor the second valid set of monitoring occasions via a second search space set associated with a second periodicity.

14. The UE of claim 1, wherein the one or more processors are individually or collectively further operable to execute the code to cause the UE to:
transmit a feedback message in response to the second signaling, the feedback message comprising an indication of the second portion of the bandwidth.

15. A network entity, comprising:
one or more memories storing processor-executable code; and
one or more processors coupled with the one or more memories and individually or collectively operable to execute the code to cause the network entity to:
output first signaling indicating a configuration for a plurality of portions of a bandwidth, the plurality of portions of the bandwidth comprising a first portion of the bandwidth and a second portion of the bandwidth that at least partially overlaps with the first portion of the bandwidth;
output second signaling indicating configuration information associated with monitoring the first portion of the bandwidth and monitoring the second portion of the bandwidth;
output, to a user equipment (UE), one or more first transmissions via the first portion of the bandwidth in a first valid set of monitoring occasions according to the configuration for the plurality of portions of the bandwidth and according to the configuration information associated with monitoring the first portion of the bandwidth;
output third signaling indicating for the UE to operate in the second portion of the bandwidth; and
output one or more second transmissions via the second portion of the bandwidth in a second valid set of monitoring occasions according to the configuration for the plurality of portions of the bandwidth and according to the configuration information associated with monitoring the second portion of the bandwidth, wherein at least one of the first valid set of monitoring occasions and the second valid set of monitoring occasions are the same.

16. The network entity of claim 15, wherein the configuration information associated with monitoring indicates a set of monitoring occasions comprising the first valid set of monitoring occasions and the second valid set of monitoring occasions.

17. The network entity of claim 16, wherein the one or more processors are individually or collectively further operable to execute the code to cause the network entity to:
select, in response to the first signaling, the first valid set of monitoring occasions; and
select, in response to the second signaling, the second valid set of monitoring occasions.

18. The network entity of claim 16, wherein the one or more processors are individually or collectively further operable to execute the code to cause the network entity to:
output, via the first signaling, a first monitoring occasion mask associated with the first portion of the bandwidth and a second monitoring occasion mask associated with the second portion of the bandwidth.

19. The network entity of claim 18, wherein the first monitoring occasion mask and the second monitoring occasion mask comprise bitmaps indicating whether one or more monitoring occasions of the set of monitoring occasions are valid.

20. The network entity of claim 15, wherein the configuration information associated with monitoring indicates the first valid set of monitoring occasions.

21. The network entity of claim 15, wherein the configuration information associated with monitoring indicates the second valid set of monitoring occasions.

22. The network entity of claim 15, wherein the second valid set of monitoring occasions excludes one or more valid monitoring occasions of the first valid set of monitoring occasions based at least in part on the one or more valid monitoring occasions of the first valid set of monitoring occasions being located outside of the second portion of the bandwidth.

23. The network entity of claim 15, wherein the one or more processors are individually or collectively further operable to execute the code to cause the network entity to:
redistribute one or more valid monitoring occasions of the first valid set of monitoring occasions to be within the second portion of the bandwidth based at least in part on the one or more valid monitoring occasions of the first valid set of monitoring occasions being located outside of the second portion of the bandwidth.

24. The network entity of claim 15, wherein the one or more processors are individually or collectively further operable to execute the code to cause the UE to:
compute one or more indices associated with a set of monitoring occasions, the set of monitoring occasions comprising the first valid set of monitoring occasions and the second valid set of monitoring occasions;
select, in response to the first signaling, the first valid set of monitoring occasions; and
select, in response to the second signaling, the second valid set of monitoring occasions.

25. The network entity of claim 15, wherein the first valid set of monitoring occasions comprises at least one monitoring occasion of the second valid set of monitoring occasions.

26. The network entity of claim 15, wherein the first valid set of monitoring occasions excludes one or more monitoring occasions of the second valid set of monitoring occasions.

27. The network entity of claim 15, wherein the one or more processors are individually or collectively further operable to execute the code to cause the network entity to:
output the one or more first transmissions via a first search space set associated with a first periodicity; and
output the one or more second transmissions via a second search space set associated with a second periodicity.

28. The network entity of claim 15, wherein the one or more processors are individually or collectively further operable to execute the code to cause the network entity to:
receive a feedback message in response to the second signaling, the feedback message comprising an indication of the second portion of the bandwidth, wherein outputting the one or more second transmissions via the second valid set of monitoring occasions is based at least in part on receiving the feedback message.

29. A method for wireless communications by a user equipment (UE), comprising:
receiving first signaling indicating a configuration for a plurality of portions of a bandwidth, the plurality of portions of the bandwidth comprising a first portion of the bandwidth and a second portion of the bandwidth that at least partially overlaps with the first portion of the bandwidth;
receiving second signaling indicating configuration information associated with monitoring the first portion of the bandwidth and monitoring the second portion of the bandwidth;
monitoring for one or more first transmissions via the first portion of the bandwidth in a first valid set of monitoring occasions according to the configuration for the plurality of portions of the bandwidth and according to the configuration information associated with monitoring the first portion of the bandwidth;
receiving third signaling indicating for the UE to operate in the second portion of the bandwidth; and
monitoring for one or more second transmissions via the second portion of the bandwidth in a second valid set of monitoring occasions according to the configuration for the plurality of portions of the bandwidth and according to the configuration information associated with monitoring the second portion of the bandwidth, wherein at least one of the first valid set of monitoring occasions and the second valid set of monitoring occasions are the same.

30. A method for wireless communications by a network entity, comprising:
outputting first signaling indicating a configuration for a plurality of portions of a bandwidth, the plurality of portions of the bandwidth comprising a first portion of the bandwidth and a second portion of the bandwidth that at least partially overlaps with the first portion of the bandwidth;
outputting second signaling indicating configuration information associated with monitoring the first portion of the bandwidth and monitoring the second portion of the bandwidth;
outputting, to a user equipment (UE), one or more first transmissions via the first portion of the bandwidth in a first valid set of monitoring occasions according to the configuration for the plurality of portions of the bandwidth and according to the configuration information associated with monitoring the first portion of the bandwidth;
outputting third signaling indicating for the UE to operate in the second portion of the bandwidth; and
outputting one or more second transmissions via the second portion of the bandwidth in a second valid set of monitoring occasions according to the configuration for the plurality of portions of the bandwidth and according to the configuration information associated with monitoring the second portion of the bandwidth, wherein at least one of the first valid set of monitoring occasions and the second valid set of monitoring occasions are the same.
